(19) United States
(12) Patent Application Publication
(10) Pub. No.: US 2016/0190984 A1
(43) Pub. Date: Jun. 30, 2016

(54) SYSTEM AND METHOD FOR PERFORMANCE ANALYSIS AND CLASSIFICATION OF LOSSES FOR SOLAR POWER SYSTEMS

(71) Applicant: Also Energy, Inc., Boulder, CO (US)

(72) Inventor: Holden R. Caine, Boulder, CO (US)

(21) Appl. No.: 14/584,202

(22) Filed: Dec. 29, 2014

(51) Int. Cl. H02S 50/10

(52) U.S. Cl. CPC H02S 50/10

(57) ABSTRACT

The invention provides a system and method for analyzing and classifying the losses of a photovoltaic array. The system and method compares expected power output and to actual power output and can determine a photovoltaic string, combiner, or inverter is generating less power than expected due to at least one of snow cover, soiling, and inverter clipping. The system and method can then determine an amount of power lost during a period of time the photovoltaic string, combiner, or inverter is experiencing snow cover, soiling, or inverter clipping and determine a value of the amount of power lost during the period of time. Various user interfaces enable a user to view one or more reasons why a PV string, combiner or inverter is generating less power than expected and the value of the amount of power lost.

### FIELD OF THE INVENTION

The invention relates to systems and methods for identifying and classifying energy losses in solar power systems and, more particularly, to assigning financial values to the losses incurred.

### BACKGROUND

Commercial and utility-scale photovoltaic (“PV”) power systems (“PV systems”) generally organize solar panels into an array of PV strings. Typically, each string contains the same number of panels as all other PV strings in the same system. The PV strings are connected together in parallel to produce the desired voltage and current necessary for efficient DC to AC conversion.

PV systems require a significant initial investment and ongoing maintenance effort in order to meet their performance and financial expectations over the lifetime of the system. Accordingly, it is important to accurately and timely monitor key parameters of the PV system to evaluate the performance of the PV system. By monitoring PV systems, component failures and losses caused by factors that negatively affect the efficiency of the PV system, such as snow accumulation and soiling of solar panels, may be identified so that a financial value of the loss may be determined.

Once a loss is identified, the financial value of the loss can be used to determine if it is economical to perform corrective action to ensure that the PV system is operating efficiently. For some losses it may not be economical to perform corrective action because the value of the lost energy is less than the cost of the corrective action. Determining the financial value of the loss becomes increasingly vital in remotely located PV systems where it may not be cost effective to send technicians to take action to mitigate a small loss.

Monitoring systems capable of direct measurement of some types of PV system losses are available and described in U.S. Pat. No. 6,425,248, U.S. Pat. No. 7,336,201, U.S. Pat. No. 7,742,897, and U.S. Pat. No. 8,738,328. The hardware and installation costs of some of these prior art monitoring systems are cost prohibitive, especially for large commercial and utility scale PV systems containing thousands of solar panels. Some of the monitoring systems rely on weather conditions at the site of the PV system to rule out certain losses, or identify losses, and may thus inaccurately classify a loss. Further, although sensors can be used to measure sunlight and temperature at a given location within the PV system, variations in irradiance and temperature over a large PV system can result in significant differences between actual and model predictions for power output at different points within the PV system.

Thus, there is a need for a system and method that can analyze the performance of PV systems to detect component failures or energy loss, classify the cause of the failure or loss, and determine the financial value of the loss while requiring minimal capital and equipment investment.

### SUMMARY OF THE INVENTION

In accordance with the invention, a PV system performance analysis and classification system and method are provided that requires considerably less hardware than existing systems. Additionally, the system and method described herein can be employed to determine a reason a photovoltaic string or inverter is generating less power than expected. After determining a reason that the photovoltaic string or inverter is generating less than the expected power, the financial impact of the losses can be calculated. The financial impact of the loss may then be used to schedule and execute maintenance operations efficiently.

In one preferred embodiment, a performance analysis system comprises: (a) measurement hardware; (b) an analysis engine; and (c) a database. The database stores monitoring conditions, performance threshold data, performance data, and analysis data. The invention is embodied within a data monitoring system including: a memory and a processor in communication with the memory, the processor operable to execute computer coded commands or instructions. The executable commands or instructions can include various software modules including: (1) an expected output module; (2) a performance module; and (3) a loss quantifier module. The expected output module determines an expected power output of one or more photovoltaic strings and inverters of the photovoltaic array. The performance module identifies a photovoltaic string or inverter that is generating less power than expected. The loss quantifier module receives the expected power output of the photovoltaic string or inverter that is generating less power than expected. The loss quantifier module then compares the expected power output to an actual power output of the photovoltaic string or inverter that is generating less power than expected. By comparing the expected power output to the actual power output, the loss quantifier module determines a reason the photovoltaic string or inverter is generating less power than expected.

Optionally, the performance analysis system may further comprise a report module. The report module can generate a report using information received from the loss quantifier module. The report can be displayed on at least one of a user interface display associated with a computer, a text message, an email message, or a printed report.

In one embodiment, the loss quantifier module is further operable to receive data from sensors of the photovoltaic array. The data comprises signals from sensors associated with combiners that combine DC power output by the one or more photovoltaic strings and inverters that convert the DC power output by the combiners into AC power.

In another embodiment, the expected output module determines the expected power output of the one or more photovoltaic strings and inverters using a model of the photovoltaic array and a model parameter that considers and evaluates a number of factors, including: (1) a position of the Sun; (2) measured irradiance at the photovoltaic array; (3) a temperature of a photovoltaic module of one of the photovoltaic strings; (4) a characteristic of the photovoltaic array; (5) a factor representing electrical losses of the photovoltaic array; (6) a factor representing electrical losses that occur when the inverters convert DC power into AC power; (7) an amount of power lost by shading of one or more of the photovoltaic strings; (8) meteorological data collected at the photovoltaic array; and (9) data received from sensors associated with combiners and inverters of the photovoltaic array.

In another embodiment, the loss quantifier module can analyze a ratio of the actual power output of the photovoltaic string or inverter to the expected power output of the photovoltaic string or inverter. Using data from the analysis, the loss quantifier module can determine whether snow cover on the array is the reason the photovoltaic string or inverter is generating less power than expected when there is a steady drop in the ratio of the actual power output to the expected power output. The loss quantifier module is further operable to determine a beginning time and an end time of a period of time of snow cover. After the loss quantifier module determines snow cover is present on the array, the loss quantifier module can also determine the amount of snow cover is decreasing when there is a steady increase in the ratio of the actual power output to the expected power output.

In still another embodiment, the loss quantifier module is operable to determine whether soiling is the reason the photovoltaic string or inverter is generating less power than expected. When a straight line fitted to a ratio of the actual power output of the photovoltaic string or inverter to the expected power output of the photovoltaic string or inverter has a negative slope over a period of two or more days, the loss quantifier module can determine soiling is the reason for the loss. The loss quantifier module is further operable to determine the amount of soiling has decreased when the ratio has a positive slope. The loss quantifier module can also determine a beginning time and an end time of a period of soiling.

In yet another embodiment of the invention, the loss quantifier module is further operable to compare the expected power output to the actual power output of the inverter for a period of time during which the inverter is generating less power than expected. If the actual power output of the inverter is substantially constant although solar irradiance at the photovoltaic array is variable during the period of time, and if the actual power output of the inverter correlates with the expected power output of the inverter, the loss quantifier module can determine that the cause of the loss is clipping by the inverter. The loss quantifier module can also determine a beginning time and an end time of a period of clipping. The loss quantifier module can then determine an amount of power lost during a period of time the photovoltaic string or inverter is generating less power than expected due to clipping and determine a value of the amount of power lost during the period of time of clipping.

In one embodiment of the invention, when determining the reason the photovoltaic string or inverter is generating less power than expected, the loss quantifier module is operable to analyze information from a second photovoltaic array. The information from the second photovoltaic array may comprise at least one of (i) an expected power output of the second photovoltaic array, (ii) an actual power output of the second photovoltaic array, and (iii) an amount of error associated with a model of the second photovoltaic array.

In accordance with another aspect of the invention, a method of analyzing the performance of a photovoltaic array is provided. This method generally comprises: (1) providing a computer readable medium including an expected output module associated with a computer processor; (2) providing a performance module associated with the computer processor; and (3) providing a loss quantifier module associated with the computer processor. The expected output module is operable to determine an expected power output of one or more photovoltaic strings and inverters of the photovoltaic array. The performance module is operable to identify a photovoltaic string or inverter that is generating less power than expected. The loss quantifier module is operable to determine a reason that the photovoltaic string or inverter is generating less power than expected.

The loss quantifier module (i) receives the expected power output of the photovoltaic string or inverter that is generating less power than expected; (ii) compares the expected power output to an actual power output of the photovoltaic string or inverter that is generating less power than expected; (iii) determines a reason the photovoltaic string or inverter is generating less power than expected; (iv) determines whether snow cover of one or more photovoltaic strings is the reason the photovoltaic string or inverter is generating less power than expected by analyzing a ratio of the actual power output of the photovoltaic string or inverter to the expected power output of the photovoltaic string or inverter; (v) determines a beginning time and an end time of a period of time of snow cover; and (vi) determines an amount of snow cover is decreasing when there is a steady increase in the ratio of the actual power output to the expected power output.

Optionally, the method may further comprise providing a report module associated with the computer processor. The report module (i) generates a report using information received from the loss quantifier module; and (ii) displays the report on at least one of a user interface display associated with a computer, a text message, an email message, or a printed report.

The loss quantifier module can also: (i) determine whether soiling is the reason the photovoltaic string or inverter is generating less power than expected when a straight line fitted to a ratio of the actual power output of the photovoltaic string or inverter to the expected power output of the photovoltaic string or inverter has a negative slope over a period of two or more days; (ii) determine an amount of soiling has decreased when the ratio has a positive slope; and (iii) determine a beginning time and an end time of a period of soiling.

The loss quantifier module also: (i) determines whether clipping is the reason the photovoltaic string or inverter is generating less power than expected when the actual power output of the inverter is substantially constant during a period of time when irradiance at the photovoltaic array is variable and when the actual power output of the inverter does correlate with the expected power output of the inverter; and (ii) determines a beginning time and an end time of a period of clipping.

The loss quantifier module can also: (i) determine an amount of power lost during a period of time the photovoltaic string or inverter is generating less power than expected; and (ii) determine a value of the amount of power lost

In accordance with another aspect of the invention, a non-transitory computer-readable medium containing computer executable instructions is provided that, when executed by a processor, cause the processor to execute a method of analyzing the performance of a photovoltaic array. The computer-readable instructions generally comprise, but are not limited to: (i) instructions to determine an expected power output of one or more photovoltaic strings and inverters of the photovoltaic array; (ii) instructions to identify a photovoltaic string or inverter that is generating less power than expected; (iii) instructions to receive the expected power output of the photovoltaic string or inverter that is generating less power than expected; (iv) instructions to compare the expected power output to an actual power output of the photovoltaic string or inverter that is generating less power than expected; (v) instructions to determine a reason the photovoltaic string or inverter is generating less power than expected, wherein the reason the photovoltaic string or inverter is generating less power than expected is at least one of snow cover, soiling, and clipping; (vi) instructions to determine an amount of power lost during a period of time the photovoltaic string or inverter is generating less power than expected; (vii) instructions to determine a value of the amount of power lost; (viii) instructions to generate a report, wherein the report includes (a) the reason the photovoltaic string or inverter is generating less power than expected, (b) the amount of power lost during the period of time, and (c) the value of the amount of power lost during the period of time; and (ix) instructions to display the report on at least one of a user interface display associated with a computer, a text message, an email message, or a printed report.

In another aspect, the instructions may further comprise (x) instructions to determine whether snow cover is the reason the photovoltaic string or inverter is generating less power than expected by analyzing a ratio of the actual power output of the photovoltaic string or inverter to the expected power output of the photovoltaic string or inverter. In another aspect, the instructions may include (xi) instructions to determine whether soiling is the reason the photovoltaic string or inverter is generating less power than expected when a straight line fitted to the ratio of the actual power output of the photovoltaic string or inverter to the expected power output of the photovoltaic string or inverter has a negative slope over a period of two or more days. The instructions may also include: (xii) instructions to determine whether clipping by the inverter is the reason the photovoltaic string or inverter is generating less power than expected when the actual power output of the inverter is substantially constant during a period of time when irradiance at the photovoltaic array is variable and when the actual power output of the inverter correlates with the expected power output of the inverter. The instructions may further include (xiii) instructions to determine a beginning time and an end time of the period of time the photovoltaic string or inverter is generating less power than expected.

The invention provides a number of advantages depending on the particular aspect, embodiment, and/or configuration. As mentioned above, the system and method disclosed herein enable a user to monitor a PV system with reduced measurement hardware while maintaining the sensitivity necessary to reliably detect string failures and performance degradation. Additionally, with respect to the analysis provided by the invention, the system and method disclosed herein allows a user or automated system to make timely decisions as to how to cost-effectively operate photovoltaic arrays. For example, after the cause of a loss has been determined by the system, the user can determine whether or not to send maintenance personnel to the PV system. For a temporary loss, such as one caused by snow accumulation, the user may determine the cost of sending maintenance personnel to remove the snow from the solar panels is not economical compared to the value of the energy lost. These and other advantages will be apparent from the disclosure.

References made herein to “photovoltaic arrays,” “photovoltaic systems,” “photovoltaic modules,” or “solar panels,” should not necessarily be construed as limiting the invention to a particular type of solar power system. It will be recognized by one skilled in the art that the invention may be used to analyze and classify losses for any type of solar power system, including concentrating solar power systems and solar thermal power systems.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium,” as used herein, refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the invention are stored. It should be noted that any computer readable medium that is not a signal transmission may be considered non-transitory.

The term “desktop,” as used herein, refers to a metaphor used to portray systems. A desktop typically includes pictures, called icons, that show applications, windows, cabinets, files, folders, documents, and other graphical items. The icons are generally selectable through user interface interaction to allow a user to execute applications or conduct other operations.

The term “display”, as used herein, refers to a portion of a display image used to display the output of a computer to a user.

The term “displayed image”, as used herein, refers to an image produced on the display. A typical displayed image is a window or desktop. The displayed image may occupy all or a portion of the display.

The term “module,” as used herein, refers to any known or later developed hardware, software, computer readable medium, firmware, artificial intelligence, fuzzy logic, or combination of hardware and software with functionality associated with a particular task and that is capable of performing the functionality associated with that task.

The term “window”, as used herein, refers to a, typically rectangular, displayed image on part of a display that contains or provides content different from the rest of the screen.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof Further, the structures, materials or acts and the equivalents thereof shall include all those described in the summary of the invention, brief description of the drawings, detailed description, abstract, and claims themselves.

The preceding is a simplified summary of the invention to provide an understanding of some aspects of the invention. This summary is neither an extensive nor exhaustive overview of the invention and its various aspects, embodiments, and/or configurations. It is intended neither to identify key or critical elements of the invention nor to delineate the scope of the invention but to describe selected concepts of the invention in a simplified form as an introduction to the more detailed description presented below. As will be appreciated, other aspects, embodiments, and/or configurations of the invention are possible utilizing, alone or in combination, one or more of the features set forth above or described in detail below.

Other features and advantages of the invention will become apparent from a review of the following detailed description, taken in conjunction with the drawings.

### BRIEF DESCRIPTION OF THE DRAWINGS

FIG. 1 is an example communications/data processing network system that may be used in conjunction with embodiments of the invention;

FIG. 2 is an example data processing system that may be used in conjunction with embodiments of the invention;

FIG. 3 is a block diagram of a PV system in conjunction with a performance analysis system;

FIG. 4 is a block diagram of an embodiment of the performance analysis system of the invention;

FIG. 5 is a block diagram of an embodiment of the analysis engine of FIG. 4;

FIG. 6A is a graph indicating loss of power caused by snow cover as determined by an embodiment of the performance analysis system of the invention;

FIG. 6B is a graph indicating an increase in power due to shedding of snow cover as determined by an embodiment of the performance analysis system of the invention;

FIG. 7 is a graph indicating a loss of power caused by soiling as determined by yet another embodiment of the performance analysis system of the invention;

FIG. 8 is a graph created by the performance analysis system of the invention indicating clipping by an inverter;

FIG. 9 is a sample user interface display image according to one embodiment of the invention illustrating performance of a plurality of PV strings and indicating losses determined by the performance analysis system to be caused by various reasons;

FIGS. 10A and 10B illustrate embodiments of a sample user interface display image according to one embodiment of the invention indicating soiling detected by the loss quantifier module;

FIG. 11 is a sample user interface display image indicating soiling detected by the loss quantifier module according to another embodiment of the invention;

FIG. 12 is yet another sample user interface display image indicating soiling detected by the loss quantifier module of yet another embodiment of the invention;

FIG. 13 is another example of a user interface display image according to another embodiment of the invention and indicating a period of snow loss detected by the loss quantifier module;

FIG. 14 is still another example of a user interface display image indicating a period of inverter clipping loss detected by the loss quantifier module according to another embodiment of the invention;

FIG. 15 illustrates an embodiment of a performance analysis method of an embodiment of the invention; and

FIG. 16 illustrates another embodiment of a performance analysis method of the invention.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The following detailed description describes one or more embodiments of the disclosed system and method. First, the detailed description provides a description of a network system and a computer system that may be used in connection with the performance analysis system and method disclosed herein. The detailed description then provides a disclosure of embodiments of the performance analysis system and method disclosed herein. The detailed description further provides various user interfaces or outputs generated by the performance analysis system and method disclosed herein.

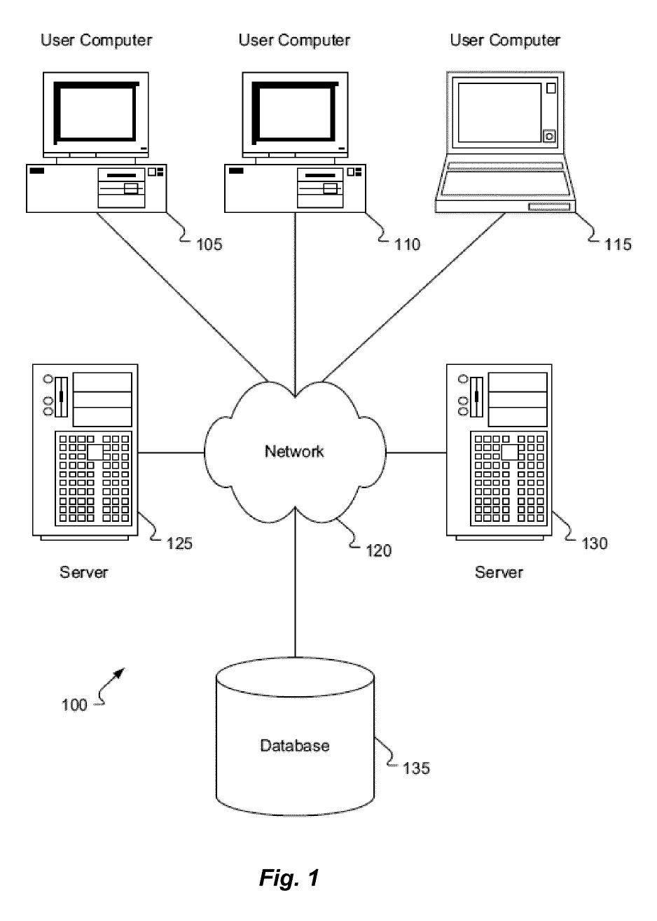

Referring to FIG. 1, an example network system is provided that may be used in connection with the performance analysis system and method disclosed herein. More specifically, FIG. 1 illustrates a block diagram of a system 100 that may use a performance analysis system to analyze the performance of a PV system and classify losses of the PV system. The system 100 includes one or more data processors, such as user computers 105, 110, and 115. The user computers 105, 110, and 115 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 105, 110, 115 may also have any of a variety of applications, including for example, database client and/or server applications, and web browser applications. Alternatively, the user computers 105, 110, and 115 may be any other electronic device, such as a thin-client computer, internet-enabled mobile telephone, and/or personal digital assistant, capable of communicating via a network (e.g., the network 120 described below) and/or displaying and navigating web pages or other types of electronic documents. Although the exemplary system 100 is shown with three user computers, any number of user computers may be supported.

System 100 further includes a network 120. The network 120 may be any type of network familiar to those skilled in the art that can support data communications using any of a variety of commercially-available protocols, including without limitation TCP/IP, SNA, IPX, AppleTalk, and the like. Merely by way of example, the network 120 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 125, 130. One server may be a web server 125, which may be used to process requests for web pages or other electronic documents from user computers 105, 110, and 120. The web server can be running an operating system including any of those discussed above, as well as any commercially-available server operating systems. The web server 125 can also run a variety of server applications, including HTTP servers, FTP servers, CGI servers, database servers, Java servers, and the like. In some instances, the web server 125 may publish operations available as one or more web services.

The system 100 may also include one or more file and/or application servers 130, which can, in addition to an operating system, include one or more applications accessible by a client running on one or more of the user computers 105, 110, 115. The server(s) 130 may be one or more general purpose computers capable of executing programs or scripts in response to the user computers 105, 110 and 115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 130 may also include database servers, including without limitation those commercially available from Oracle, Microsoft, Sybase™, IBM™ and the like, which can process requests from database clients running on a user computer 105.

In some embodiments, an application server 130 may create web pages dynamically for displaying information and reports generated by the performance analysis system. The web pages created by the web application server 130 may be forwarded to a user computer 105 via a web server 125. Similarly, the web server 125 may be able to receive web page requests, web services invocations, and/or input data from a user computer 105 and can forward the web page requests and/or input data to the web application server 130.

In further embodiments, the server 130 may function as a file server. Although for ease of description, FIG. 1 illustrates a separate web server 125 and file/application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) one or more of the computers 105, 110, 115, 125, 130. Alternatively, it may be remote from any or all of the computers 105, 110, 115, 125, 130, and in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10i™, that is adapted to store, update, and retrieve data in response to SQL-formatted commands.

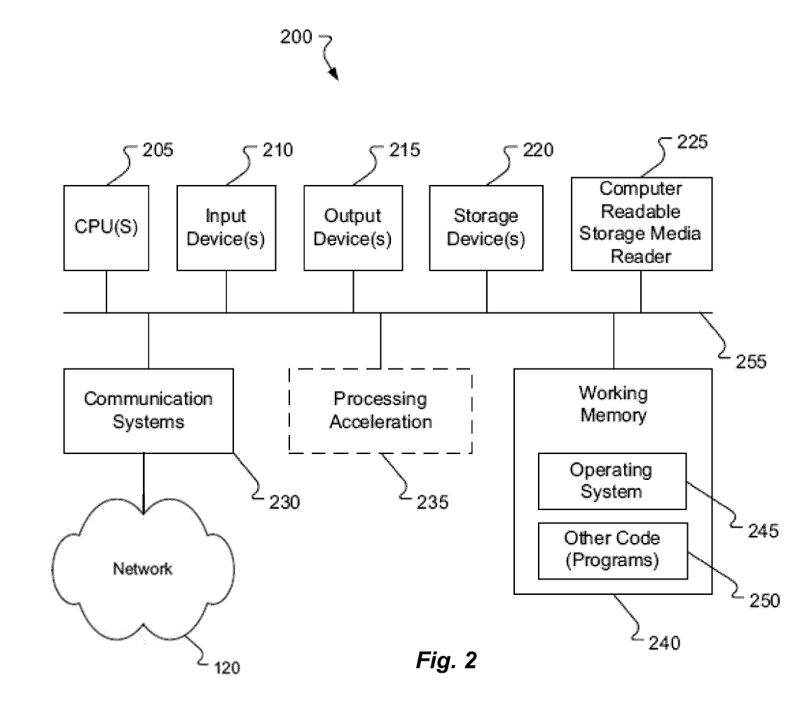

Referring to FIG. 2, an example data-processing system is provided that may be used in connection with the performance analysis system and method disclosed herein. More specifically, FIG. 2 illustrates one embodiment of a data-processing system 200 upon which the performance analysis system or components of a performance analysis system may be deployed or executed. The data-processing system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The data-processing system 200 may also include one or more storage devices 220. By way of example, storage device(s) 220 may be disk drives, optical storage devices, solid-state storage device such as a random access memory (“RAM”) and/or a read-only memory (“ROM”), which can be programmable, flash-updateable and/or the like.

The data-processing system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the data-processing system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 120 and/or any other data-processing described above with respect to the system 100.

The data-processing system 200 may also comprise software elements, shown as being currently located within the working memory 240, including an operating system 245 and/or other code 250, such as program code implementing a performance analysis system or components of a performance analysis system. It should be appreciated that alternate embodiments of a data-processing system 200 may have numerous variations from that described above. For example, customized hardware might also be used and/or particular elements might be implemented in hardware, software (including portable software, such as applets), or both. Further, connection to other computing devices such as network input/output devices may be employed.

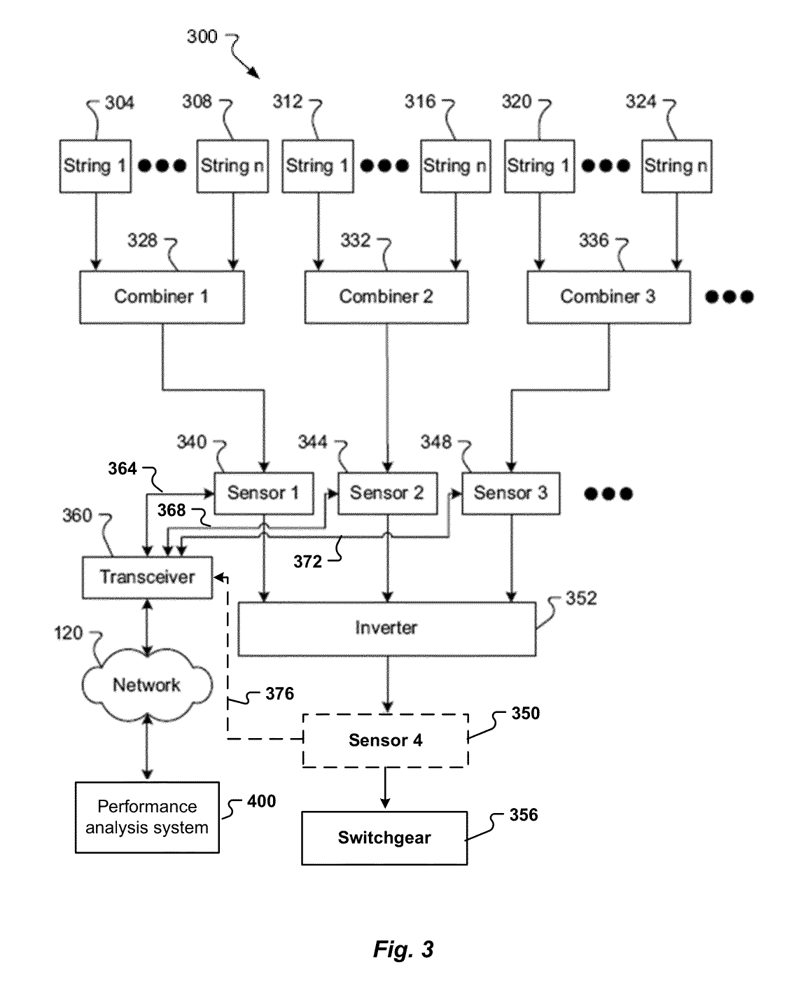

FIG. 3 depicts a block diagram of the electrical layout of a PV system 300 that includes a plurality of PV strings 304, 308, 312, 316, 320, 324, a plurality of combiners 328, 332, 336, and an inverter 352. Each PV string consists of individual solar panels, typically eight to twelve panels, wired in series. The output signals of the PV strings are wired, in parallel, into the combiners 328, 332, 336. Each combiner can receive output signals from one or more PV string. For example, in FIG. 3, PV String 1 304 through PV String n 308 are wired into combiner 1 328, PV String 1 312 through PV String n 316 are wired into combiner 2 332, and PV String 1 320 through PV String n 324 are wired into combiner 3 336. Each combiner sums the data signals of their PV strings, thereby providing a cumulative direct current (“DC”) power output that is associated with a plurality of PV strings. The output signals of the combiners are wired into an inverter 352. In FIG. 3, only one inverter is illustrated. However, in large PV systems, multiple inverters are employed, each accepting the output signals of multiple combiners. The inverter 352 converts the DC power of the solar panels into three phase alternating current (“AC”) power which ultimately can be used by commercial power systems. The three phase AC power leaves the inverter 352 and is wired into the switchgear 356 of the facility where the AC output of the PV system 300 is matched to supply power to the facility or to a utility grid.

As illustrated in FIG. 3, measurement hardware, such as sensors 340, 344, 348, detect the input signals of the inverter 352. In some embodiments, the measurement hardware includes sensor 350 that detects the output signals of the inverter 352. The sensors may be separate from the inverter 352, or the sensors may be incorporated into the inverter 352. Optionally, measurement hardware, such as sensors 340, 344, 348, can measure the output of each individual string 304-324 instead of the output of combiners 328, 332, 336. The choice of how many strings 304-324 each sensor measures is a tradeoff between the cost of the sensors required and the signal to noise ratio for detecting a single string failure.

By locating the sensors near the inverter 352, the hardware costs, such as the quantity of sensors and associated wiring, is significantly reduced. This is especially important for large PV systems where thousands of strings are employed. Each sensor 340, 344, 348, 350, and the individual data entries detected by the sensor, is associated with a data channel. As shown in FIG. 3, sensor 1 340 is associated with a first data channel 364, sensor 2 344 is associated with a second data channel 368, sensor 3 348 is associated with a third data channel 372, and sensor 4 350 is associated with a fourth data channel 376. Each data channel is associated with the individual data entries detected by the respective sensors.

To further reduce hardware costs, in at least one embodiment, each combiner sums the output of at least six PV strings, and preferably, at least twelve PV strings. This reduces the number of combiners required in a PV system, as well as reducing the number of sensors and associated wiring required to monitor the performance of the PV system. Accordingly, each sensor detects data that is associated with a plurality of PV strings. This data is collected and analyzed by the performance analysis system 400 to analyze and classify losses of the PV system 300.

In the ideal case, the signal to noise level can be defined as 1/n, where n is the number of strings in a group. For example, with ten strings per group, a single string failure would result in a ten percent reduction in current at the inverter input. However, the ideal case is not achievable because the signal-to-noise ratio is further reduced due to measurement errors, differences between solar panels, mounting, and environmental conditions such as cloud shading, soiling (dirt on the panels), and obstructions. Embodiments of the performance analysis system and method utilize a number of approaches to compensate for these noise issues, thus enabling the detection of single string failures or performance degradation from a data channel associated with a plurality of PV strings.

Referring back to FIG. 3, the sensors 340, 344, 348, 350 are in communication with a transceiver 360, which transmits the sensor data through the network 120 to the performance analysis system 400. The sensor data may be at least one of current and voltage data. Examples of sensors include, but are not limited to, voltage transformers (VT), current transformers (CT), and Hall Effect sensors. As shown in FIG. 3, each sensor 340, 344, 348, is associated with an output signal of a combiner, which is the summation of a plurality of PV strings. Sensor 350 is associated with an output signal of the inverter 352. Accordingly, the sensor data that is transmitted to the performance analysis system 400 is associated with a plurality of PV strings and inventers.

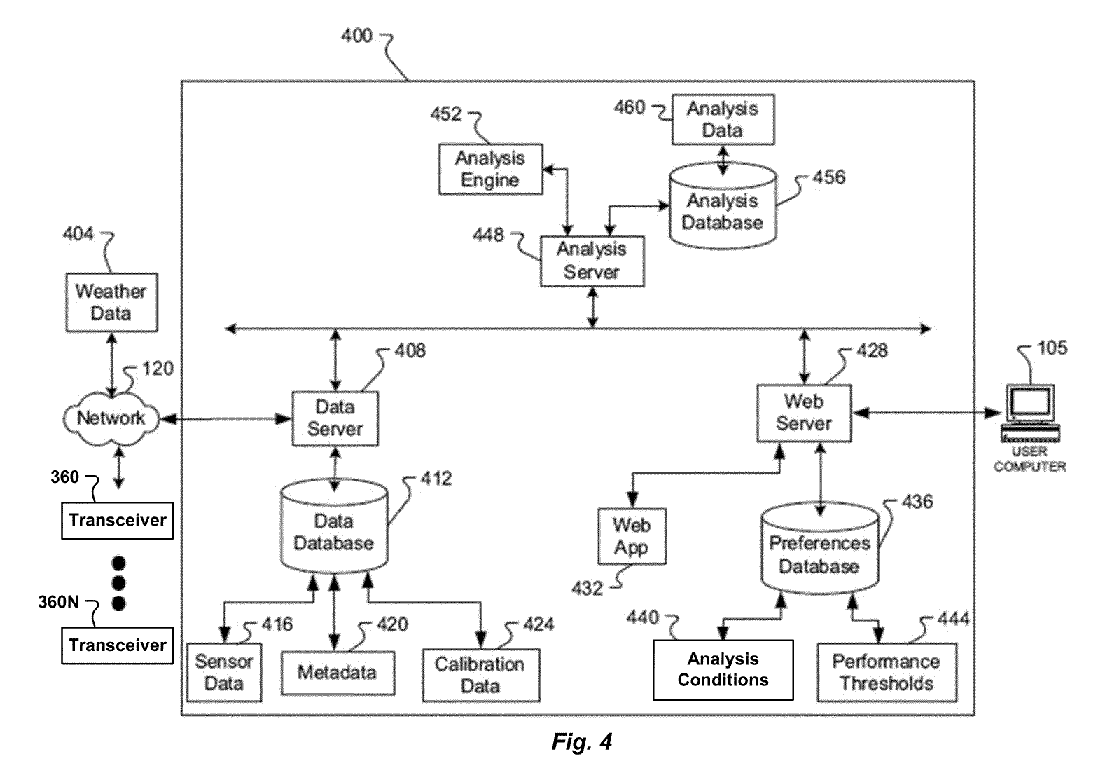

FIG. 4 illustrates an embodiment of the performance analysis system 400 discussed above in connection with FIG. 3. As shown in FIG. 4, the performance analysis system 400 includes multiple servers and databases. The number and configuration of the servers and databases are shown for illustration purposes only, and may be altered without departing from the scope of the invention. For example, a single server and database may be utilized. As depicted in FIG. 4, a data server 408 is in communication with the network 120 and receives sensor data from one or more transceivers 360 . . . 360N associated with one or more PV systems 300 . . . 300N. Optionally, the data server 408 may receive weather data 404. The weather data 404 may originate from a weather substation located at each of the PV systems 300, and may include environmental conditions such as solar radiance, wind speed, wind direction, temperature, rain, snow, and humidity. Optionally, weather data 404 may be obtained from multiple locations within a PV system 300 to detect and characterize weather variations within the PV system 300. For example, some PV systems 300 may include sensors that collect weather data 404 at each string or for all strings associated with a combiner. Measuring the solar radiance, using a pyranometer, allows the performance analysis system 400 to evaluate the impact of smog, haze, or clouds when determining an expected power output for each PV system 300 using a model for the PV system 300.

The data server 408 communicates with a data database 412, which stores sensor data 416, metadata 420, and calibration data 424 for each PV system 300 being monitored. Sensor data 416 may be voltage data or current data, and may include instantaneous values as well as time-averaged data. The sensor data 416 may include information received from each sensor 340, 344, 348, 350 for the life of the PV system 300. Metadata 420 includes data associated with the sensor data, such as weather data, timestamp, combiner identification, inverter identification, sensor identification, and angle of the sun. Calibration data 424 includes the initial calibration data recorded when each PV system 300 was first commissioned as well as periodic calibration data initiated by the performance analysis system 400. The calibration data 424 is associated with the data channels 364, 368, 372, 376 of the sensors 340, 344, 348, 350 of each PV system 300.

The data server 408 also communicates with a web server 428. The web server 428 communicates with a user computer 105, a web application 432, and a preferences database 436. The web application 432 includes a user interface that allows a user to monitor the performance of one or more of the PV systems 300-300N, to set analysis conditions 440, and to set performance thresholds 444. Additionally, the web application 432 may generate alerts notifying a user of performance issues identified by the performance analysis system 400. The web application 432 may also generate user configurable display images or user interfaces, discussed in more detail below, to information to a user.

The analysis conditions 440 are intended to limit the analysis of the performance analysis system 400 to periods of time when each PV system 300 should be producing at least a minimum amount of power. At low power levels, measurement and other errors represent a larger contribution to the data than at higher power levels. Thus, by restricting the analysis to those times when the string power is above a preset threshold, the reliability of the performance analysis system 400 is improved. Analysis conditions 440 include the time of day the performance analysis system 400 will monitor the performance of each PV system 300, the position of the sun, geometric interference shading data, a minimum solar irradiation level, a minimum current or voltage level, and a minimum power level.

Performance thresholds 444 are used to detect an underperforming PV string. Performance thresholds 444 include a comparator and a deviation value. Comparators include a specification performance comparator, a statistical average performance comparator, a channel-to-channel comparator, and a time-differential comparator. A specification performance comparator comprises comparing the actual performance of a plurality of PV strings and/or the PV array with the optimal performance of the strings and/or the PV system. The optimal performance, or expected output, of the PV strings and/or the PV system is determined by the analysis engine 452.

A statistical average performance comparator comprises comparing the actual performance of a plurality of PV strings with the statistical average performance of the strings, which may be determined during a testing phase of the PV system. A channel-to-channel comparator comprises comparing the actual performance of a plurality of PV strings with the actual performance of another plurality of PV strings. In some embodiments, a data entry received by one data channel may be compared to a data entries received from multiple other data channels. Additionally, in some embodiments, the channel-to-channel comparator may compare data entries associated with similar sun positions, even if the data entries were not detected at the same time or date. A time-differential comparator comprises comparing the actual performance of a plurality of PV strings with the performance of the plurality of PV strings at an earlier date. The time-differential comparator compares data entries associated with similar sun positions. For example, the time-differential comparator may compare a data entry associated with a plurality of PV strings with a data entry associated with the same plurality of PV strings but detected one year earlier. Shorter-term comparisons, such as daily comparisons, help the performance analysis system 400 quickly identify and classify a failure or loss whereas longer-term comparisons, such as yearly comparisons, help the performance analysis system 400 identify performance degradation issues that are hard to detect in shorter-term comparisons. A single performance threshold comparator, or any combination thereof, may be utilized. In at least one embodiment, a channel-to-channel comparator and a time-differential comparator are utilized. The deviation value comprises a percentage variance that the actual performance can vary from the comparator value. The deviation value includes a predefined percentage, a standard deviation value, or a production impact.

The analysis conditions 440 and the performance thresholds 444 may be user-selectable. In one configuration, the user may set the conditions 440 and thresholds 444 via a web application 432. During development testing, a simulated run-time environment is provided that can execute the conditions and thresholds under a set of predefined conditions. The simulations performed during development testing allow the user to test, debug and perfect the analysis conditions and performance thresholds before deployment. The simulated run-time environment testing package is stored in a database for continued development and editing, thereby allowing a user to test new analysis conditions and performance thresholds before entering them into the production web servers. Accordingly, a user may set the conditions and thresholds under which the performance analysis system 400 will analyze the sensor data and monitor performance of a PV system 300. The conditions and thresholds may have predefined default values which will be used by the performance analysis system 400 until a user overrides the default values by entering a user-selectable value.

An analysis server 448 is also provided in the performance analysis system 400. The analysis server 448 communicates with the data server 408, the web server 428, as well as the analysis engine 452 and the analysis database 456. The analysis database 456 stores the analysis data 460, which includes the calculated angle of the sun at any moment in time and the geometric interference shading data associated with the PV system 300.

The analysis engine 452 calculates the angle of the sun based on time of year, the time of day, and the latitude and longitude of the PV system. Using the angle of the sun, the analysis engine 452 can determine geometric interferences that will shade all or a portion of the PV system 300. The geometric interference shading data enables the analysis engine 452 to identify low performance as geometric interference shading rather than a failure or performance degradation. Additionally, the geometric interference data may be used as a performance analysis condition 440 to limit analysis of the portion of the PV system 300 that is affected by the geometric interference shading. The analysis engine 452 also uses the angle of the sun and geometric interference information as well as weather data 404 to determine the expected output of individual PV strings and/or each PV system 300 by using a PV system model.

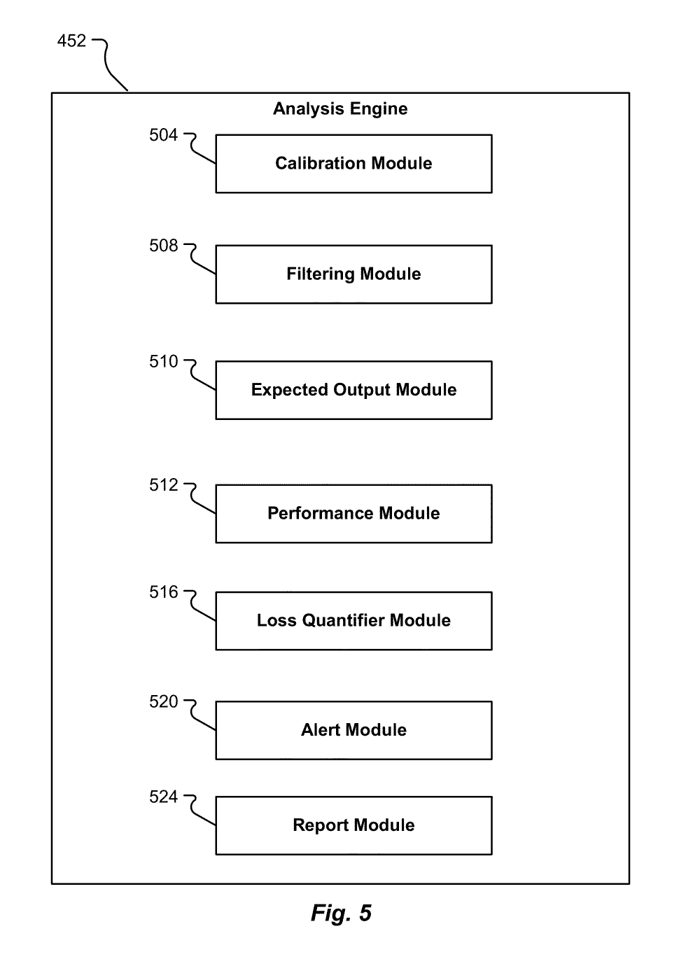

Referring to FIG. 5, the analysis engine 452 of the invention is illustrated with a calibration module 504, a filtering module 508, an expected output module 510, a performance module 512, a loss quantifier module 516, an alert module 520, and a report module 524. As described above, modules may be a computer readable medium with functionality associated with a particular task. The calibration module 504 automatically calibrates the sensors 340, 344, 348, 350. The automatic calibration is initially performed when the PV system 300 is first commissioned and all strings, string 1 304 . . . string n 324, are confirmed to be operating, thus ensuring that a string failure is not mistakenly classified as a gain discrepancy. To eliminate the effect caused by differences in gain and offset for each sensor, samples are taken at night to determine the measurement offset and during periods of peak sunlight levels to determine the gain. The offset and gain factors are applied to the sensor data to normalize the data and remove the hardware effects. The calibration is limited by the accuracy ratings of the measurement hardware and the maximum differences due to panel performance variances. Calibration values outside of these limits indicate a failure or component that is out of specification.

Besides an initial calibration, the calibration module also performs frequent calibration readings to verify the sensor hardware is still within specification and to compare the offset and gain values to the initial calibration values. Variances in calibration values may indicate a component failure or a PV string performance issue. For example, a panel that is known to have a degraded or damaged surface (such as chipping or scratching) that is no-longer transparent will not have as high of an output as a panel with a transparent surface, even if exposed to the same amount of sunlight. Accordingly, in response to a degraded panel, the calibration module 504 may re-calibrate the sensor hardware to take into account the reduced output attributed to the condition. Also, the calibration module 504 may instruct the alert module 520 to generate an alert notifying the user that the sensor is out-of-specification and that the calibration module 504 has re-calibrated the sensor to limit further alerts. Without re-calibrating the equipment, the environmental condition would continue to generate alerts and may inaccurately be flagged as a PV string failure.

The filtering module 508 limits the analysis to periods of time when the PV system 300 should be producing at least a minimum amount of power. By restricting the analysis to those times when the string power is above a predetermined threshold, the performance analysis system 400 will reduce unnecessary alerts that may be generated due to noise being a large contribution to the data. To filter the data, the filtering module 508 retrieves sensor data 416, metadata 420, and calibration data 424 from the data database 412, analysis conditions 440 from the preferences database 436, and analysis data 460 from the analysis database 456.

The expected output module 510 determines the expected output of individual PV strings, combiners, inverters, and/or each PV system 300 using the weather data 404 and a PV system model. The PV system model and the sequence of calculations used to determine the expected output of the PV system (and the individual strings, combiners, and inverters of the PV system) consider measured irradiance and other site conditions such as string orientation, latitude, longitude, elevation, and others. These calculations represent set of known relationships within a PV system 300. The PV model typically starts with measured irradiance and module temperature. Given those values, and by applying the appropriate transforms based on latitude, longitude, elevation, time of day, day of the year, PV string azimuth and tilt and other characteristics of the PV system, the output power (electrical kW) is calculated from the input solar irradiance (watts per meter), temperature, and other measurements. Each component of the PV system can be modeled by functions of varying complexity, often simply as a constant multiplier. The basic model corresponds to the PV system as follows:
1. Convert measured irradiance to Plane of Array (POA) irradiance which is the amount of sunlight falling on the PV strings.
2. Adjust the irradiance for angle of incidence (the solar panels of each PV string may have difference characteristics for how well they absorb sunlight from different angles).
3. Adjust the irradiance for atmospheric effects (air mass). The spectrum of sunlight changes as a function of how much atmosphere there is in the optical path.
4. Adjust for shading due to obstacles.
5. Adjust the PV string efficiency. PV strings operate at different efficiencies depending on the amount of sunlight and the temperature as well as differences in quality and size of the solar panels used to form each PV string. PV strings may also perform less efficiency over time, so age of the PV string may be considered by the PV model.
6. Adjust for inverter efficiency. The inverter converts the DC power from the PV system in AC power, and the conversion efficiency varies as a function of power level and other effects. Further, the efficiency of the inverter may decrease over time, so the PV model may adjust for the age of the inverter or other components of the PV system.
7. Apply a de-rate factor to compensate for various losses, such as wiring and transformer losses.
   The PV system model used by the expected output module 510 may be created during the design phase of the PV system 300 and adjusted using calibration data 424 when the PV system was first commissioned and during the testing phase of the PV system. The expected power output generated using the PV system model is used to help identify and characterize losses of the PV system. One example of a reference that describes modeling of a PV system is the Applicant's copending U.S. patent application Ser. No. 14/326,342, which is incorporated herein by reference in its entirety.

The performance module 512 detects an underperforming PV string, combiners, or inverter. To detect a failure or performance degradation, the performance module 512 retrieves performance thresholds 444 from the preferences database 436 and sensor data 416 from the data database 412. Then, the performance module 512 compares the sensor data 416 with the performance thresholds 444. If the data entry is not within the performance thresholds, the performance module 512 informs the loss quantifier module 516 and the alert module 520 that the data entry is in an alarm condition. An example of a system and method for monitoring the performance of a PV system is described in the Applicant's U.S. Pat. No. 8,725,437, which is incorporated herein by reference in its entirety.

The loss quantifier module 516 uses the expected power output of individual PV strings, combiners, inverters, and the PV system received from the expected output module 510 and the actual power output received from the transceiver 360 to categorize the cause of a loss. Other data, such as historical actual power output data of the PV system, and the individual PV strings, combiners, and inverters of the PV system, may be received from sensor data 416, metadata 420, and calibration data 424. Actual and expected power output may also be received from other PV systems, and PV strings, combiners, and inverters of other PV system, and considered by the loss quantifier module 516.

A loss can be caused by one or more of soiling, snow cover, shading, clipping, a wiring failure, a PV array or solar panel failure, an aging loss, an inverter failure, or a measurement error. Each cause of a loss creates identifiable patterns in the power output and other data received from the PV system 300. The loss quantifier module 516 can identify and differentiate between patterns in the data to determine a variety of conditions that may be affecting power production. Losses due to shading and equipment failures can be differentiated by the loss quantifier module 516 from losses due to snow cover, soiling, and clipping by the inverter. Further, a loss can be caused by more than one individual event. For example, the loss quantifier module 516 can identify a power loss caused by a combination of snow cover, soiling, and clipping and determine the amount of power loss attributed to each individual cause (for example, a 5% loss due to soiling, a 20% loss due to snow cover, and a 10% loss due to clipping during a single day).

Once a pattern associated with one or more causes of a loss are identified and the condition causing the loss is determined, the associated energy loss can be calculated for each condition. A rate schedule is then applied to the energy loss to determine the associated financial impact. The loss quantifier module 516 also calculates the amount of energy lost, and the value of the lost energy, due to each cause. The loss quantifier module 516 informs the alert module 520 of the cause of the loss, the amount of energy lost, and the value of the lost energy. The financial impact of the loss is determined by multiplying the amount of energy lost by the value of that energy. The loss quantifier module 516 is operable to consider variable energy rates due to demand charges, time of use rates, tiers, and other pricing schemes when determining the value of energy lost due to snow cover.

The alert module 520 monitors data channels with data entries in an alarm condition. If the channel remains in an alarm condition for a predetermined period of time, the alert module 520 generates an alert using the web application 432 to notify a user of an issue with the data channel. The alert may contain sensor data, metadata, calibration data, analysis data, the performance threshold, the cause of the loss, the amount of energy lost, and the value of the lost energy. Additionally, the alert module 520 may generate varying levels of alerts. For example, the alert module 520 may include three alert levels, a failure level, a loss level, and a detection level, depending on the variance of the sensor data from the performance thresholds. A failure level alert would be sent to the user and state that a failure has occurred. A loss level alert would be sent to the user and state that a loss has been detected and classified. A detection level alert would be sent to the user but would inform the user that the data channel is under investigation and that the performance analysis system 400 will continue to monitor the channel to determine whether there is a failure, a loss, or performance degradation and to classify the failure, loss, or performance degradation.

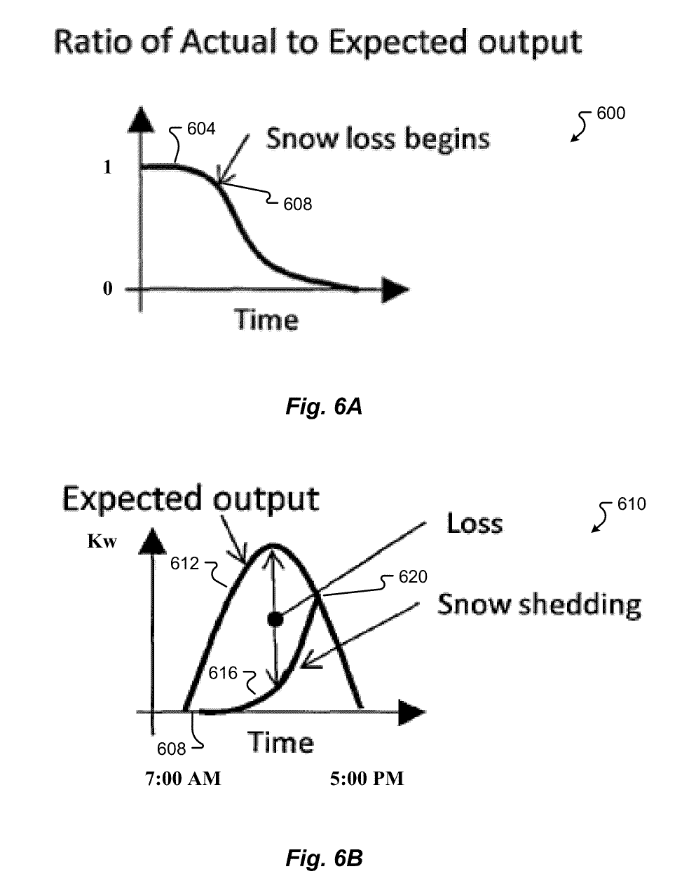

The report module 524 uses information from the loss quantifier module 516 to generate user interfaces or display images to information about the loss to a user. The reports can be presented to a user in one or more graphs or display images, discussed in more detail below in conjunction with FIGS. 6A-14. The format and information presented by the report module 524 in the display images may be altered by a user to show specific periods of time for one or more PV systems or for individual components of a PV system, such as one or more inverters or PV strings of a PV system. Further, a user can request a report about the performance of one or more inverters or PV strings at any time. The report module 524 will retrieve the information required for the requested report from the loss quantifier module 516, the data database 412, and the analysis database 456 and generate the report.

Referring now to FIGS. 6A-6B, to determine snow cover on a PV string of a PV system, the loss quantifier module 516 examines the actual power output relative to the expected power output. Weather data 404 may indicate snow cover is a possible cause for a loss indicated by a lower than expected power output. However, weather data 404 alone is generally not sufficient to determine the beginning and end of a period of snow cover or the amount of loss that may be attributed to the snow cover. Factors such as the mounting characteristics of individual solar panels or PV strings, the tilt of the solar panels, and micro-climates within the PV system can result in differences in snow cover between locations within the PV system.

Referring now to FIG. 6A, a typical graph 600 of actual power output relative to expected power output indicating snow cover is illustrated. The Y-axis of the graph represents the ratio of actual to expected power output of the a PV string, combiner, inverter, or PV system and the X-axis indicates time. A steady drop in the ratio 604 between the actual to expected power outputs indicates with a high degree of certainty that snow cover is the cause of the loss. The beginning of the period of snow cover may also be indicated at point 608 by the slope of the ratio 604.

Referring now to FIG. 6B, a second graph 610 comparing expected power output 612 and actual power output 616 is illustrated. The Y-axis of the graph represents power output of a PV string, combiner, inverter, or PV system and the X-axis indicates time during a period when the PV system 300 should be producing at least a minimum amount of power. The units of the X-axis and Y-axis will vary based on the time of year, the component of the PV system being analyzed, and the size of the PV system. A steady increase in the actual power output 616 approaching the expected power output 612 indicates a reduction in snow cover due to the amount of snow cover decrease, such as by melting or sliding off of the solar panels. The end 620 of the period of snow cover is determined by the loss quantifier module 516 when the actual power output 616 is substantially equal to the expected power output 612.

Once a period of time is determined to include a loss due to snow cover of at least one string, combiner, or inverter of the PV system, the loss quantifier module 516 can quantify the amount of energy lost by calculating the difference between the expected power output 612 and the actual power output 616 from the start 608 to the end 620 of the period of snow cover. The financial impact of the loss is then determined by multiplying the amount of energy lost by the value of that energy. The loss quantifier module 516 is operable to consider variable energy rates due to demand charges, time of use rates, tiers, and other pricing schemes when determining the value of energy lost due to snow cover. In one embodiment, graphs 600 and 610 may be presented to a user by the report module 524 using the web application 432.

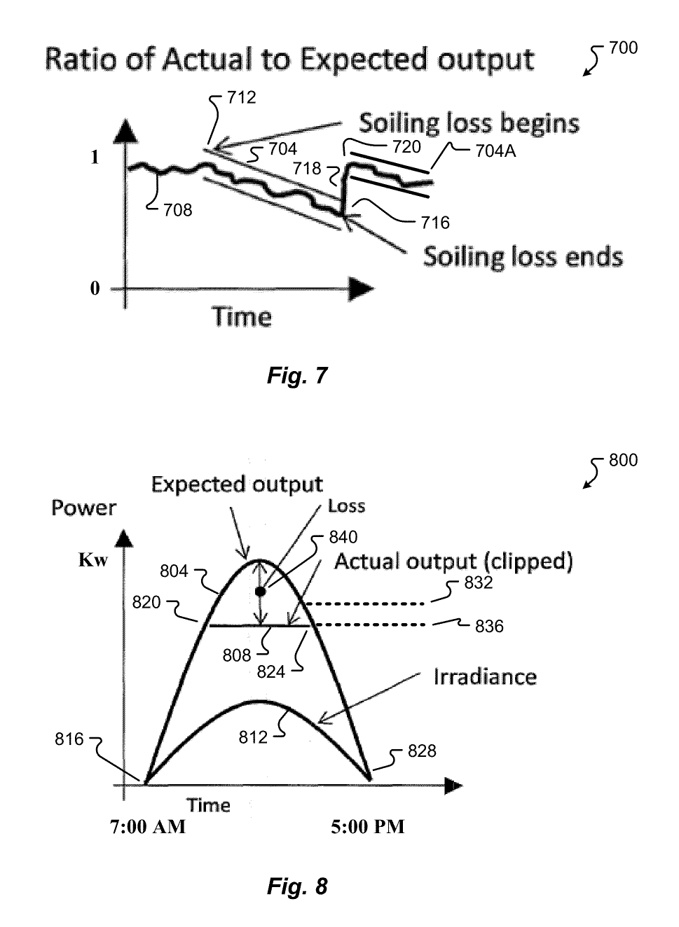

Referring now to FIG. 7, a typical graph 700 of actual to expected power output of a PV string, combiner, inverter, or PV system over a period of time indicating a loss due to soiling is illustrated. The Y-axis of the graph represents the ratio of actual to expected power output of the PV system (or a PV string, combiner, or inverter of the PV system) (typically at single day intervals) and the X-axis indicates time. Under extended periods of dry or occasional light rain, contaminants such as dirt and dust can accumulate on the solar panels of a PV system, greatly reducing energy production. The detection and quantification of soiling losses helps determine when cleaning the PV system is financially advantageous.

The accumulation of contaminants on the solar panels generally occurs at a consistent rate. The loss quantifier module 516 can determine that a loss is due to soiling by fitting a straight line 704 to the average daily ratio 708 of actual to expected power output by the PV string, combiner, inverter, or the PV system over a period of time. The beginning of a period of soiling can be identified by the point 712 when the slope of the line 704 becomes negative and within a reasonable range for the PV system being monitored. Losses due to soiling typically increase at a rate of between about 0.25% to about 2.0% per day. The rate of increase in the loss due to soiling may change due to environmental conditions, the location of the PV system, and mounting and surface characteristics of the solar panels of the PV system. Further, similar to snow accumulation on solar panels, the rate of soiling can vary between individual solar panels within the PV system. Thus, the loss quantifier module 515 can identify individual PV strings within the PV system that have more or less soiling than other PV strings. This information is particularly useful in large PV systems where it is cost prohibitive to clean all of the PV strings but may be economically feasible to clean certain PV strings.

The loss quantifier module 515 can also identify a point 716 where the soiling loss ends (or when the amount of soiling has decreased) which is indicated by a non-linear increase 718 in the ratio 708 of actual to expected power output resulting in a positive slope in ratio 708. Point 716 may indicate an environmental event, such as wind or precipitation, or a manual cleaning of the solar panels. The slope of line of the ratio at 718 may approach an infinite value depending on how quickly the soiling loss ends. The loss quantifier module 515 may then identify a point 720 of the beginning of a new period of loss due to soiling.

The amount of energy lost due to soiling is calculated by the loss quantifier module 515 by multiplying the soiling percentage for each day by the expected energy production for each day. The financial impact of the soiling loss is then determined by multiplying the amount of energy lost by the value of that energy as discussed above with respect to FIGS. 6A and 6B. In one embodiment, graph 700 may be presented to a user by the report module 524 using the web application 432.

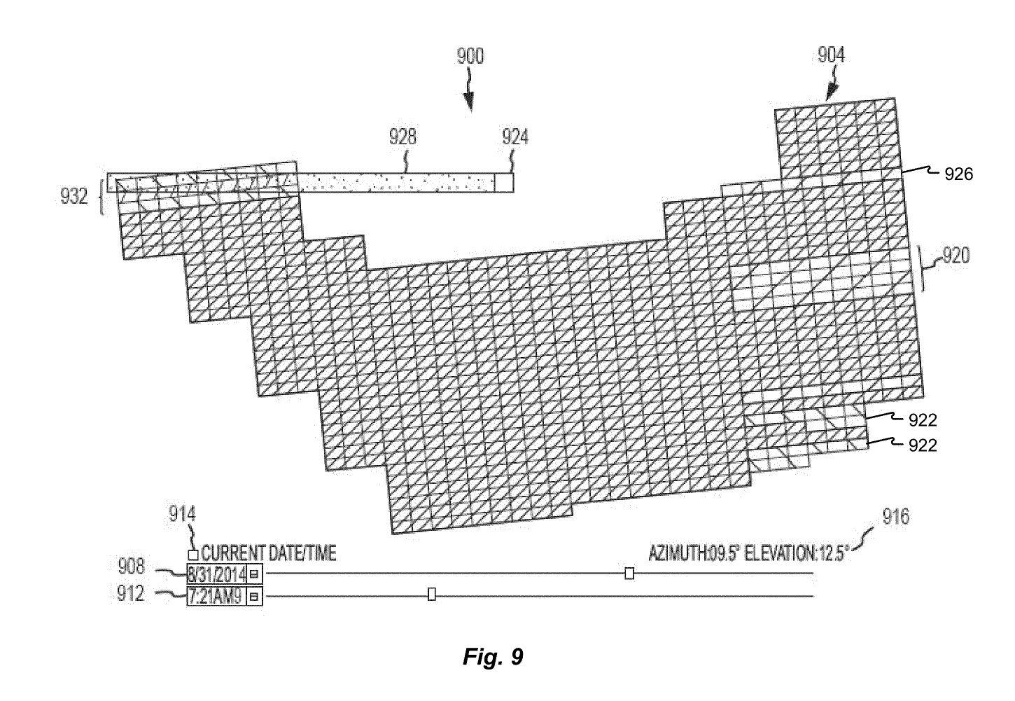

Referring now to FIG. 8, a graph 800 comparing expected power output 804 and actual power output 808 for an inverter of a PV system is illustrated. The Y-axis of the graph represents power output by the inverter and the X-axis indicates time during a period when the strings of the PV system 300 should be producing at least a minimum amount of power. The units of the X-axis and Y-axis will vary based on the time of year and the size of the inverter 352.

The DC power output for a PV system is often larger than the capacity of the inverter 352 that converts the DC power into AC power. When the PV system generates more power than the inverter 352 can convert, the power output by the PV system is “clipped.” PV system designers know that the PV system will rarely operate at the maximum expected power output due to the varying position of the sun and environmental conditions. Because of this, during the design of the PV system, an inverter 352 with a maximum capacity that is less than the maximum expected power output of the PV system is generally selected based on cost considerations because inverters are expensive.

The loss quantifier module 516 can identify time periods of varying irradiance 812 when the inverter 352 output measured by sensor 350 fails to correlate with the expected power output 804. For example, from points 816 to 820 and from points 824 to 828, the expected power output 804 and actual power output 808 are substantially the same. However, from points 820 to 824, the expected and actual power outputs 804, 808 are different and the actual power output 808 has a slope of approximately zero indicating the maximum capacity of the inverter 352 has been reached and the power output has been clipped. If there are numerous points on a given day near the highest power output recorded for the day, and there is a range of irradiance during those times, there is a high probability that the inverter is clipping.

Some clipping due to the power generated by the PV system reaching the maximum capacity of the inverter 352 is normal and expected. However, clipping below this level normally indicates a problem with the inverter 352 that may require further investigation and/or maintenance. For example, if the rated capacity of the inverter 352 is indicated by line 832 and the observed clipping occurs at line 836, there may be a problem with the inverter 352.

Because the amount of energy produced by PV systems is generally very linear with respect to the amount of sunlight received (measured in watt/m²), the loss quantifier module 516 can be quantified by calculating the ratio of power output to irradiance during periods when the inverter is not clipping. This ratio is then used to estimate the amount of power that would have been output during the period of time between points 820, 824 when the inverter is clipping. The financial impact of the clipping loss 840 is then determined by multiplying the amount of energy lost by the value of that energy as discussed above. In one embodiment, graph 800 may be presented to a user by the report module 524 using the web application 432.

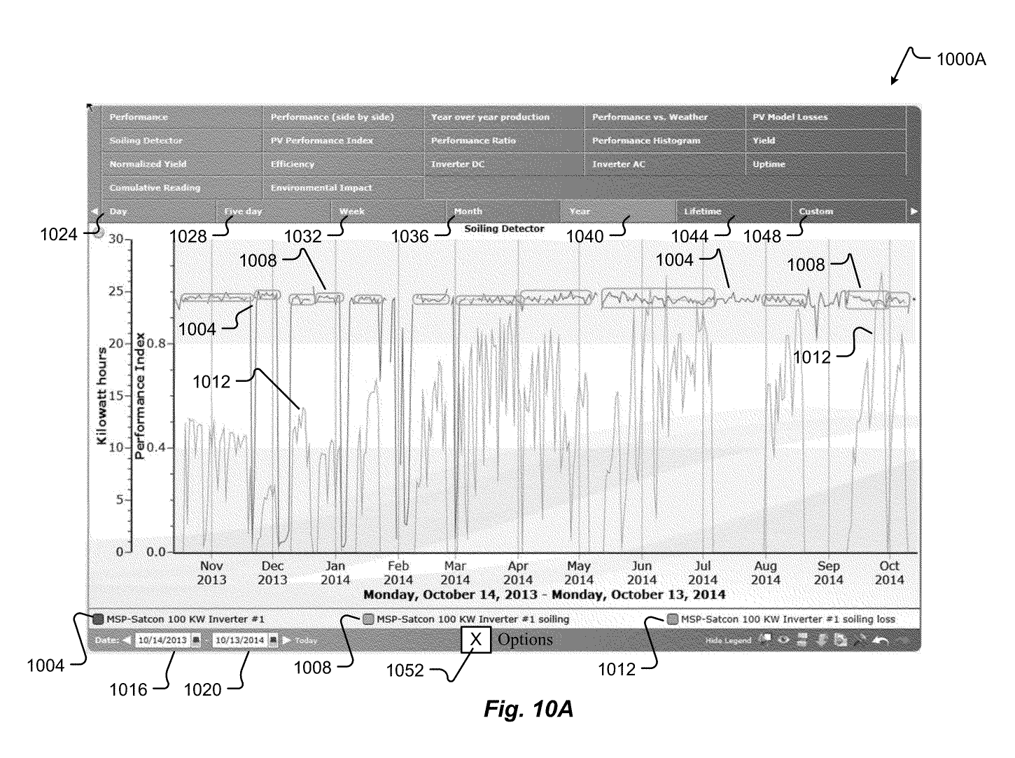

Referring now to FIG. 9, a sample user interface display image 900 is provided illustrating a PV system layout. Display image 900 graphically depicts the performance of a PV system 904 and provides a user an immediate visual representation of the exact location of underperforming PV strings and the reason for the losses associated with the underperforming PV stings. In one embodiment, display image 900 is presented to a user by the report module 524 using the web application 432.

Each PV string can be identified by the user, for example, by a mouse roll-over feature in which the coordinates of each PV string or any other type of identifying description is displayed. The display image 900 allows the user to review the performance of a PV system 904 at any moment in time by providing options to select a date 908 and a time 912 associated with the performance data, including an option 914 to view the real-time performance of the PV system 904. The display image 900 also displays the sun position 916, including azimuth and elevation, associated with the performance data. A video or animate option may be provided allowing the user to view the performance of a PV system 904 over a period of time.

The display image 900 visually indicates, in color, performance differences of various PV strings of the PV system 904 identified by the loss quantifier module 516. In one embodiment, a color scheme may comprise green, yellow, red, and combinations thereof; however, one of skill in the art will recognize that any color may be used and that a user may select certain colors to indicate particular types of losses. For example, PV strings 920 are underperforming due to snow accumulation and thus may be displayed in a yellowish color or in some other manner. PV strings 922 have been identified by the loss quantifier module 516 as experience soiling. Although soiling frequently occurs at a uniform rate within a PV system, localized conditions may cause one or more strings to accumulate contaminates while other strings do not. For example, strings 922 are located near an exterior edge of the PV system and may therefore receive more soiling from a nearby source of particulates that accumulate on PV strings 922. PV string 926 of one inverter have been identified as clipping below the expected level and may thus be displayed in a reddish color or in some other manner, such as by flashing.

By providing the user a visual depiction of the performance of PV strings within a PV system 904, display image 900 allows the user to quickly determine the location of possible failures or performance losses and the reasons for the losses. This helps reduce troubleshooting costs by allowing the user to focus on a specific location within the PV system 904.

Additionally, FIG. 9 illustrates that the performance analysis system 400 and the loss quantifier module 516 can differentiate between the effects of geometric interference, such as shading, and losses due to snow accumulation, soiling, or clipping. As illustrated, a vertical structure, such as a windmill 924, is located near the PV system 904. Based on the position of the sun 916, the performance analysis system 400 can determine the location of a shadow 928 created by the windmill 924, which is then displayed in the display image 900. As shown, the shadow 928 is cast over PV strings 932, thus affecting their performance. By using display image 900, the user can quickly determine that the underperformance of strings 932 is caused, at least in part, by the shadow 928 created by the windmill 924. Accordingly, the user can divert their attention to other areas of the PV system 904 that are underperforming. Other performance depiction schemes, beyond colors, may be utilized. The shading simulation can be used to identify times of the day and year when certain parts of the PV system 904 will underperform. This information can prevent alerts from being generated that would otherwise appear as a string failure.

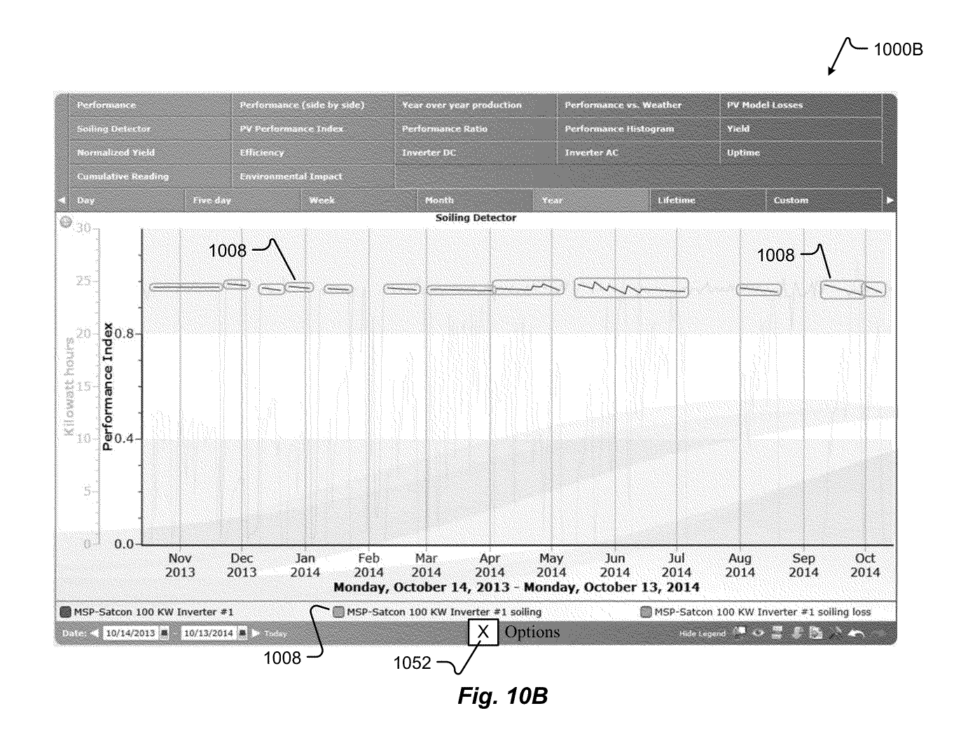

Referring now to FIG. 10A, a sample user interface display image 1000A is provided illustrating a report of soiling detected by the loss quantifier module 516. The display image 1000A graphically depicts the ratio 1004 of actual to expected power output by an inverter, multiple periods 1008 of loss due to soiling, and the loss 1012 caused by the soiling. The display image 1000A allows the user to review the amount of soiling loss of an inverter within the PV system or all inverters of the PV system. The user is given options to select a beginning date 1016 and an ending date 1020 associated with the display image 1000A. Alternatively, the user can select from preconfigured periods for a single day 1024, five days 1028, a week 1032, a month 1036, a year 1040 (which is currently highlighted indicating it has been selected), the lifetime 1044 of the PV system, or a custom period 1048. By selecting the options button 1052, the user can view the ratio of actual to expected power output by one or more strings or combiners associated with the inverter.

In FIG. 10B, a modified display image 1000B similar to display image 1000A is illustrated. In display image 1000B, the ratio 1004 of power output and the loss 1012 attributed to soiling have been de-emphasized by the user to make the periods 1008 of soiling identified by the loss quantifier module 516 more apparent. Some of the periods 1008 of soiling are separated indicating the soiling has been removed or reduced by cleaning or environmental events. In one embodiment, display images 1000A and 1000B may be generated by the report module 524 using the web application 432 and presented to a user.

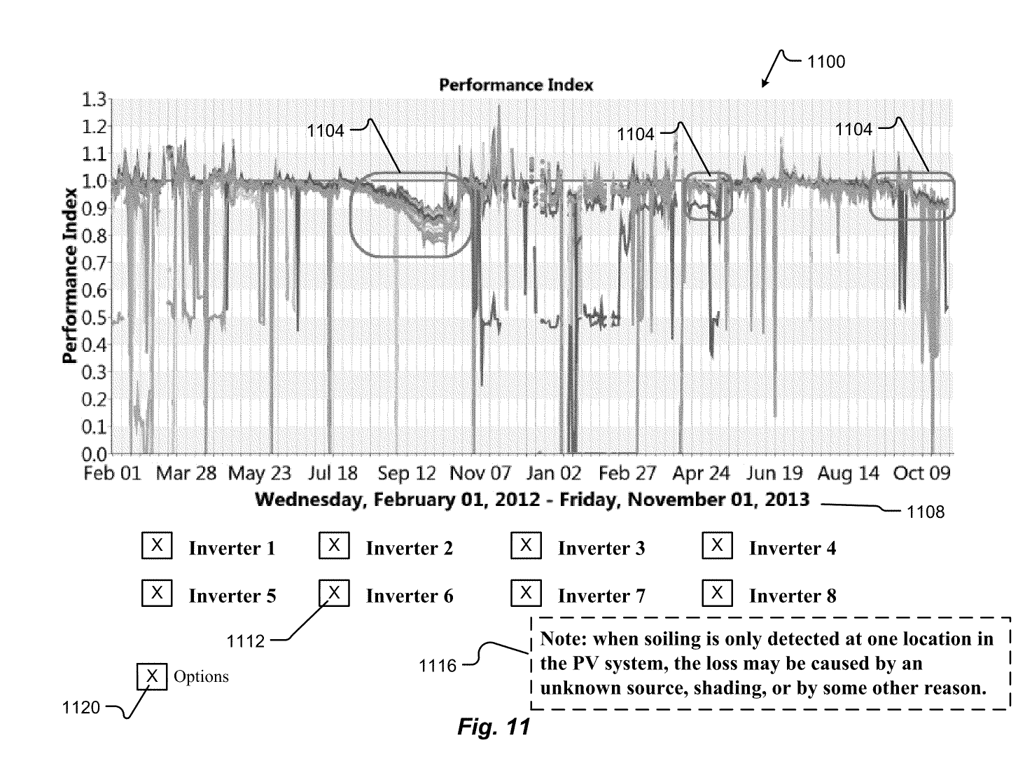

Referring now to FIG. 11, another sample user interface display image 1100 is provided illustrating a report of soiling detected by the loss quantifier module 516. Display image 1100 may be generated by the report module 524 using the web application 432 and presented to a user. Display image 1100 illustrates soiling loss data for eight inverters of a PV system for the lifetime of the PV system. The user can select the number of inverters to display on display image 1100 by clicking on one or more of the buttons 1112. For example, the user can remove the results of one or more of the inverters to focus on one or more of the other inverters. Additionally, the user may select the options button 1120 to view the performance index of one or more strings or combiners associated with one or more of inverters 1-8.

Areas showing soiling greater than a predetermined rate are highlighted by boxes 1104, although other methods of highlighting soiling may be used. Soiling frequently occurs at a uniform rate within a PV system. Accordingly, soiling is normally identified for from multiple strings, combiners, or inverters of the PV system as shown in box 1104. This fact can be used to increase the certainty that a performance loss is due to soiling. If the loss quantifier module 516 detects soiling in one part of the PV system but no soiling in other parts of the PV system, then the cause of the loss may not be soiling. The loss quantifier module 516 can re-evaluate the part of the PV system identified as having a loss due to soiling to determine if the loss is due to some other cause, such as shading or an unknown cause.

When the loss quantifier module 516 detects soiling in only one part of the PV system, the report module 524 can provide a message on display image 1100 to indicate that the loss may not be caused by soiling. For example, if soiling is only identified in a few strings of the PV system (such as strings 922 illustrated in FIG. 9), the report module 524 may optionally include a message 1116 on display image 1100. Message 1116 may indicate to the user that the loss quantifier module 516 has identified a loss for one or more strings, combiners, or inverters as possibly due to soiling, but because the soiling is not uniform throughout the PV system, the cause of the loss may be due to an unknown source, shading, or some other reason.

Although display image 1100 shows a nine month period 1108, it should be understood that the user can select any desired period of time for display by display image 1100. For example, the user can set the period of time displayed to be a single day, five days, a week, a month, a year, the lifetime of the PV system, or a custom period of time for display in display image 1100.

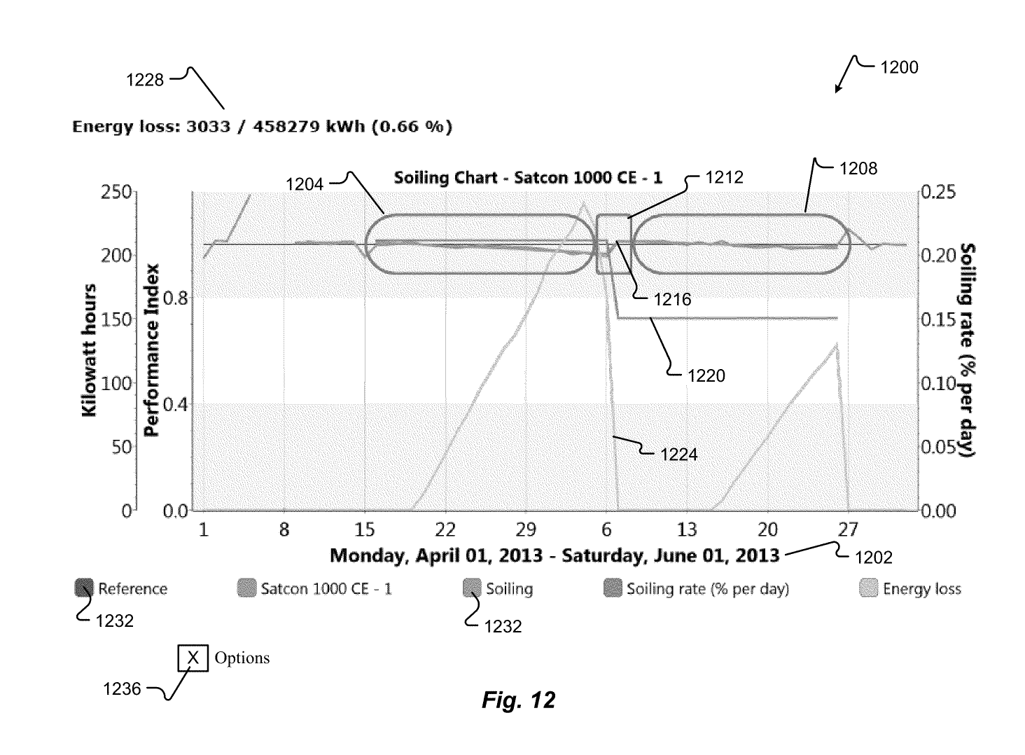

Yet another sample user interface display image 1200 generated by the report module 524 using the web application 432 is provided in FIG. 12. Display image 1200 shows the effect of soiling on a single inverter over a two month period 1202 as identified by the loss quantifier module 516. Although display image 1200 illustrates a two month period 1202 of soiling loss identified by the loss quantifier module 516, the user may change the period of time used by display image 1200 to any desired length of time. For example, in a manner similar to that displayed in FIG. 10A, the user may select a single day, five days, a week, a month, a year, the lifetime of the PV system, or a custom period of time for display in display image 1200. Further, the user may select an options menu 1236 to view the effect of soiling on one or more strings or combiners of the PV system.

Two periods of soiling 1204, 1208 have been identified and are separated by a cleaning or rain event 1212 indicated by a positive slope 1216 in the ratio of actual to expected power output. The rate of soiling buildup 1220 is calculated as a percentage of production loss per day. The amount of energy lost 1224 due to soiling is also indicated. The display image 1200 also shows a total amount of energy lost 1228 due to soiling during the two month period compared to a total amount of energy generated during the period 1202. The user may show or hide any of the information graphed in display image 1200 by selecting one or more of the buttons 1232.

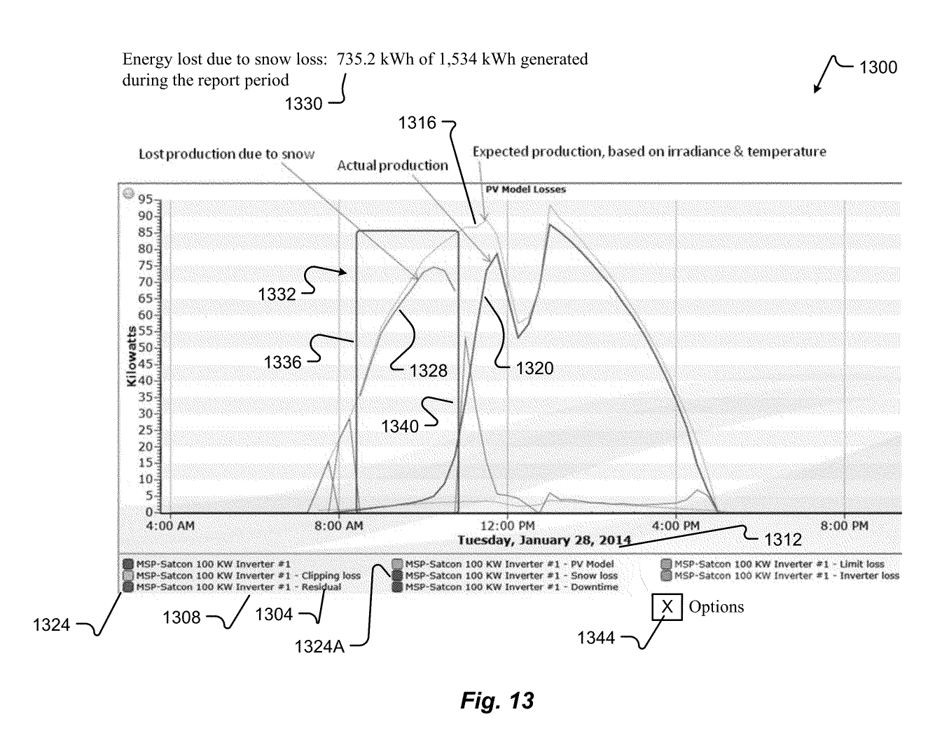

Referring now to FIG. 13, still another sample user interface display image 1300 generated by the report module 524 using the web application 432 is illustrated. Display image 1300 shows various losses 1304 (such as, but not limited to, clipping, residual, snow, downtime, limit loss, and inverter loss) that can be displayed for a single inverter 1308 as identified by the loss quantifier module 516. Although display image 1300 illustrates a single day period 1312, the user may change the period of time used by display image 1300 to report losses. For example, in a manner similar to that displayed in FIG. 10A, the user may select a single day, five days, a week, a month, a year, the lifetime of the PV system, or a custom period of time for display in display image 1300.

Display image 1300 indicates an expected power output 1316 determined by the expected output module 510 and the actual power output 1320 received from the transceiver 360. As previously described, the loss quantifier module 516 categorizes the cause of losses. The user can select one or more of the buttons 1324 to choose one or more of the various potential losses 1304 to be displayed in display image 1300. In the example illustrated in FIG. 13, the user has selected button 1324A associated with snow loss and display image 1300 shows a period of snow loss 1328 caused by snow accumulation on the solar panels of the PV system that has been identified by the loss quantifier module 516. Display image 1300 may also provide a display 1330 of the total amount of energy lost due to snow accumulation. The display 1330 also includes a total amount of energy produced during the period 1312, similar to display 1228.

Optionally, display image 1300 may include a box 1332 to highlight or emphasize the location of the snow loss 1328. Additionally, the box 1332 may indicate when the snow loss began 1336 and ended 1340. One of skill in the art will recognize that box 1332 may be displayed in various ways to visually indicate a period of snow loss and the beginning and ending of the snow loss. The user may select the options button 1344 to display or hide the box 1332. The options button 1344 may also be selected to change the period of time of the X-axis or the scale of the Y-axis of display image 1300. The user may also select the options button 1344 to choose one or more strings or combiners associated with inverter #1. The report module 524 may then generate another user interface similar to display image 1300 for the one or more strings or combiners chosen by the user.

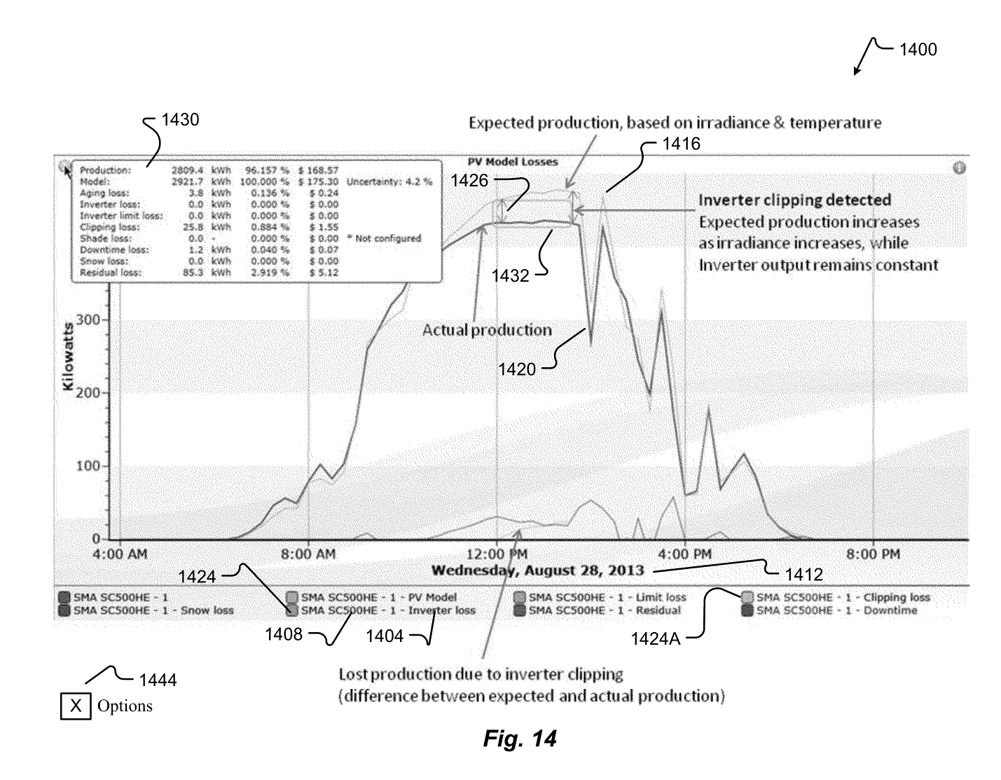

Referring now to FIG. 14, yet another sample user interface display image 1400 generated by the report module 524 using the web application 432 is illustrated. Similar to display image 1300, display image 1400 shows various losses 1404 that can be displayed for a single inverter 1408 as identified by the loss quantifier module 516. Display image 1400 illustrates losses for a period 1412 of a single day although the user may change the period as desired to show a single day, five days, a week, a month, a year, the lifetime of the PV system, or a custom period of time for display in display image 1400.

In the example illustrated in FIG. 14, the user has selected button 1424A associated with clipping losses and display image 1400 shows a period of clipping loss 1426 identified by the loss quantifier module 516. The expected power output 1416 determined by the expected output module 510 and the actual power output 1420 received from the transceiver 360 are also displayed on the display image 1400.

Display image 1400 also includes a display 1430 of a total amount of power produced, the total expected power put, and aging, inverter, inverter limit, clipping, shade, downtime, snow, and residual losses identified by the loss quantifier module 516, similar to displays 1228 and 1330. Display image 1400 further includes optional box 1432 to highlight or emphasize the location of the clipping loss 1426. Additionally, the box 1432 indicates when the clipping loss began and ended. The user may select the options button 1444 to display or hide the box 1432 or to change the period of time of the X-axis or the scale of the Y-axis of display image 1400.

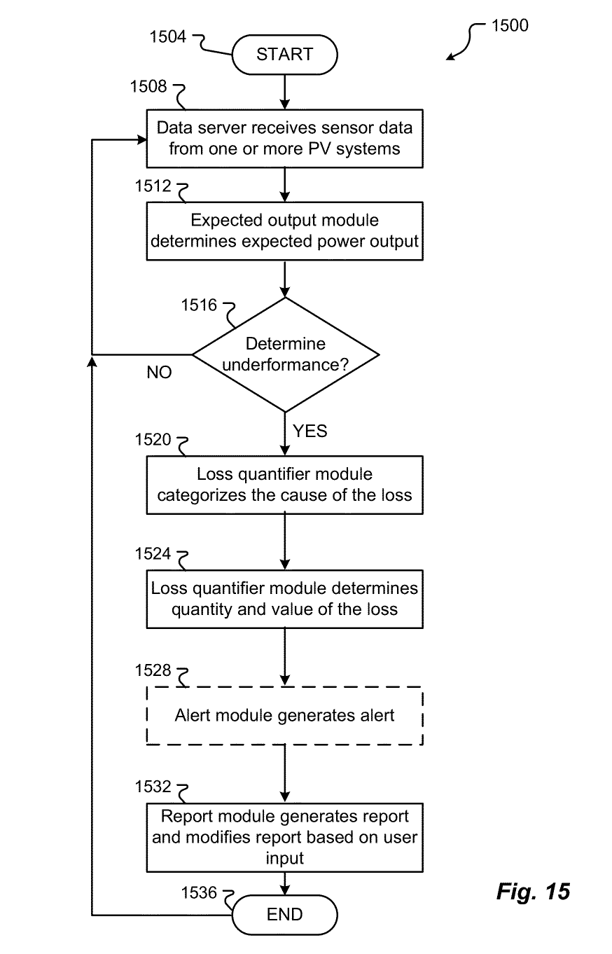

Referring now to FIG. 15, an embodiment of a performance analysis method 1500 of the invention is illustrated. While a general order for the steps of the method 1500 is shown in FIG. 15, the method 1500 can include more or fewer steps or can arrange the order of the steps differently than those shown in FIG. 15. Further, two or more steps may be combined into one step. Generally, the method 1500 starts with a start operation 1504 and ends with an end operation 1536. The method 1500 can be executed as a set of computer-executable instructions executed by a data-processing system and encoded or stored on a computer readable medium. Hereinafter, the method 1500 shall be explained with reference to the systems, components, modules, software, data structures, user interfaces, etc. described in conjunction with FIGS. 1-14.

At step 1508, the data server 408 of the performance analysis system 400 receives sensor data from one or more transceivers 360 . . . 360N associated with one or more PV systems 300 . . . 300N. The expected output module 510 uses the sensor data to determine the expected output of each PV system and/or for individual PV strings, combiners, and inverters within each PV system at step 1512. Then, at step 1516, the performance module 512 can determine if there are any underperforming PV strings, combiners, or inverters. If no underperforming PV strings, combiners, or inverters are identified, method 1500 loops NO to step 1508 and repeats.

If an underperforming PV string, combiner, or inverter is identified, method 1500 continues YES to step 1520 and the loss quantifier module 516 uses the expected power output received from the expected output module 510 and the actual power output received from the transceiver 360 to categorize the cause of the loss. The loss quantifier module 516 may also use other information, such as historical actual power output data of the PV system received from the data server 408 as well as actual and expected power output received from other PV systems to categorize the cause of the loss. The loss quantifier module 516 then determines the quantity and value of the loss. The alert module 520 may, optionally, generate an alert of the loss at step 1528.

The report module 524 receives information from the loss quantifier module 516, the data database 412, and the analysis database 456 at step 1532 and generates a report for the user. The report can be the same as, or similar to, the graphs and user interfaces illustrated in any of FIGS. 6-14. The report may include information about the loss such as the cause (such as, for example, snow coverage, soiling, or inverter chipping), an amount of energy lost by the loss, and a value of the lost energy. The report can include information about multiple inverters as illustrated in display image 1100, and about one or more of the PV strings and combiners associated with the inverters. Additionally, the report may be modified by the user. The user may change a time period displayed by the report, the number of PV arrays, inventers, combiners, or PV strings displayed in the report, and add or remove information to the report. For example, the user can remove information displayed in one user interface to emphasize other information (as shown in display images 1000A and 1000B in FIGS. 10A, 10B, and as show by boxes 1332 and 1342). Method 1500 may then End (step 1536) or return to step 1508

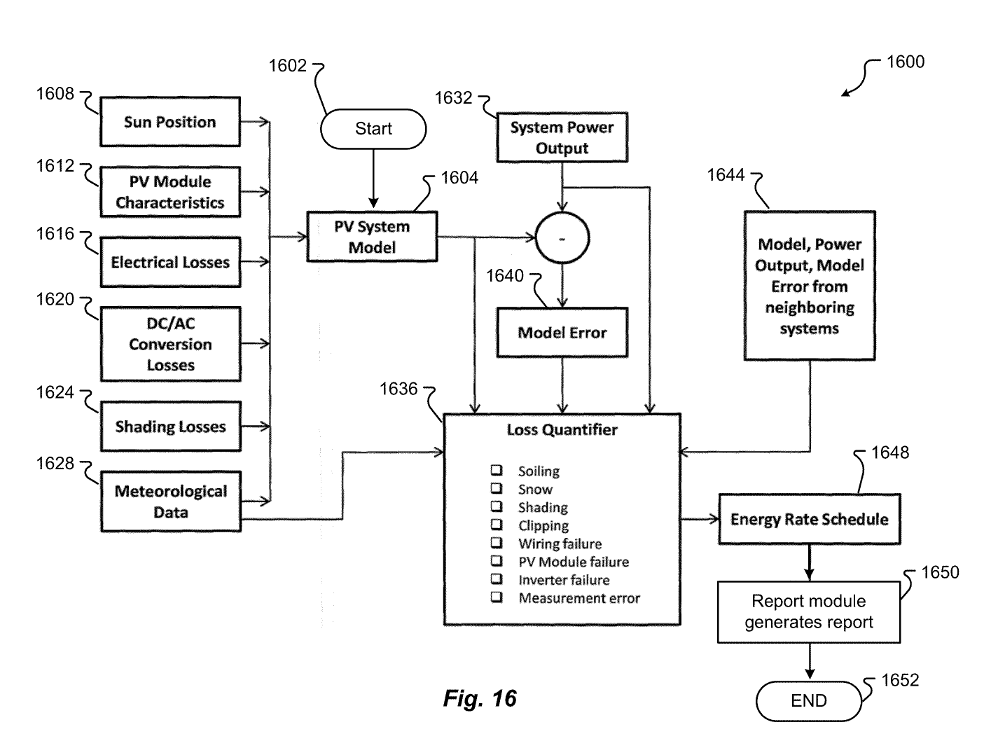

Referring now to FIG. 16, an embodiment of another performance analysis method 1600 of the invention is illustrated. While a general order for the steps of the method 1600 is shown in FIG. 16, the method 1600 can include more or fewer steps or can arrange the order of the steps differently than those shown in FIG. 16. Further, two or more steps may be combined into one step. Generally, the method 1600 starts with a start operation 1602 and ends with an end operation 1652. The method 1600 can be executed as a set of computer-executable instructions executed by a data-processing system and encoded or stored on a computer readable medium. Hereinafter, the method 1600 shall be explained with reference to the systems, components, modules, software, data structures, user interfaces, etc. described in conjunction with FIGS. 1-15.

After starting 1602, the expected output module 510 uses the PV system model 1604 to determine an expected power output of the PV system and the inverters, combiners, and PV arrays of the PV system. The expected output module 510 receives information such as sun position 1608, PV system characteristics 1612, predicted electrical losses 1616, DC to AC conversion losses and inefficiency of the inverter 1620, predicted and/or known shading losses 1624, and meteorological data 1628.

The performance module 512 then receives the actual power output 1632 of the PV arrays, combiners, and inverter and determines if there is an underperforming PV string, combiner, or inverter or if a PV string, combiner, or inverter is experiencing a loss. If there is a loss or underperforming PV string, combiner, or inverter, the loss quantifier module 516 can categorize the cause of the loss 1636. The loss quantifier module 516 may receive information about an error 1640 in the PV system model 1604 or a correction value for the PV system model 1604. The loss quantifier module 516 may also receive the expected power output, actual power output, and model error information from another PV system 1644 within a predetermined proximity to the PV system being evaluated or at a similar latitude and altitude. The loss quantifier module 516 may then determine the loss is due to one or more of soiling, snow coverage, shading, clipping, a wiring failure, a PV string, combiner, and/or inverter failure, or a measurement error by one or more of the sensors 340, 344, 348, 350. The loss quantifier module 516 can then determine the amount of energy lost due to each cause and determine a value of the energy lost at step 1648. The report module 524 receives information from the loss quantifier module 516, the data database 412, and the analysis database 456 and generates a report 1650 for the user. The report can be the same as, or similar to, the graphs and user interfaces illustrated in any of FIGS. 6-14.

The method 1600 may then end at step 1652. Method 1600 may loop to 1602 and repeat. In one embodiment of the invention, method 1600 repeats at least 1 time per hour. In another embodiment, method 1600 repeats approximately every 15 minutes. In still another embodiment, method 1600 repeats every 5 minutes.

The foregoing discussion has been presented for purposes of illustration and description. The foregoing is not intended to limit the disclosure to the form or forms disclosed herein. In the foregoing Detailed Description for example, various features of the invention are grouped together in one or more aspects, embodiments, and/or configurations for the purpose of streamlining the disclosure. The features of the aspects, embodiments, and/or configurations of the invention may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate embodiment of the invention.

The invention, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the invention. The invention, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

Although the invention describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the invention.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

In the foregoing description, for the purposes of illustration, methods were described in a particular order. It should be appreciated that in alternate embodiments, the methods may be performed in a different order than that described, and that changes, additions, and omissions to the order of the methods can occur without materially affecting the operation of the disclosed embodiments, configurations, and aspects of the invention. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Optionally, the systems and methods of this invention can be implemented in conjunction with a special purpose computer, a special purpose data-processing system, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Moreover, though the description has included description of one or more aspects, embodiments, and/or configurations and certain variations and modifications, other variations, combinations, and modifications are within the scope of the invention, e.g., as may be within the skill and knowledge of those in the art, after understanding the invention. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. While the invention has been discussed with respect to various embodiments, it shall be understood that various other changes and modifications to the invention can be made in accordance with the scope of the claims appended hereto.

What is claimed is:

1. A system for analyzing the performance of a photovoltaic array, the system comprising:
a memory;
a processor in communication with the memory, the processor operable to execute computer readable medium instructions, comprising:
an expected output module that determines an expected power output of one or more photovoltaic strings and inverters of the photovoltaic array;
a performance module that identifies a photovoltaic string or inverter that is generating less power than expected;
a loss quantifier module that:
receives the expected power output of the photovoltaic string or inverter that is generating less power than expected;
compares the expected power output to an actual power output of the photovoltaic string or inverter that is generating less power than expected; and
determines a reason the photovoltaic string or inverter is generating less power than expected; and
a report module that, as a result of the computer readable medium instructions, generates output indicating the reason the photovoltaic string or inverter is generating less power than expected, and provides the report to a user.

2. The system of claim 1, wherein the loss quantifier module receives data from sensors of the photovoltaic array, wherein the data comprises signals from sensors associated with combiners and inverters of the photovoltaic array, wherein the combiners combine DC power output by the one or more photovoltaic strings, and wherein the inverters convert the DC power output by the combiners into AC power.

3. The system of claim 1, wherein the expected output module determines the expected power output of the one or more photovoltaic strings and inverters with a model of the photovoltaic array and a model parameter comprising at least one of: a position of the Sun; measured irradiance at the photovoltaic array; a temperature of a photovoltaic module of one of the photovoltaic strings; a characteristic of the photovoltaic array; a factor representing electrical losses of the photovoltaic array; a factor representing electrical losses that occur when the inverters convert DC power into AC power; an amount of power lost by shading of one or more of the photovoltaic strings; meteorological data collected at the photovoltaic array; and data received from sensors associated with combiners and inverters of the photovoltaic array.

4. The system of claim 1, wherein the loss quantifier module determines snow cover is the reason the photovoltaic string or inverter is generating less power than expected by analyzing a ratio of the actual power output of the photovoltaic string or inverter to the expected power output of the photovoltaic string or inverter.

5. The system of claim 4, wherein the loss quantifier module:
determines snow cover is the reason when there is a steady drop in the ratio of the actual power output to the expected power output; and
determines a beginning time and an end time of a period of snow cover.

6. The system of claim 5, wherein the loss quantifier module determines an amount of snow cover is decreasing when there is a steady increase in the ratio of the actual power output to the expected power output.

7. The system of claim 1, wherein the loss quantifier module determines soiling is the reason the photovoltaic string or inverter is generating less power than expected when a straight line fitted to a ratio of the actual power output of the photovoltaic string or inverter to the expected power output of the photovoltaic string or inverter has a negative slope over a period of two or more days.

8. The system of claim 7, wherein the loss quantifier module:
determines an amount of soiling has decreased when the ratio has a positive slope; and
determines a beginning time and an end time of a period of soiling.

9. The system of claim 1, wherein the loss quantifier module:
determines clipping is the reason the photovoltaic string or inverter is generating less power than expected when the actual power output of the inverter is substantially constant during a period of time when irradiance at the photovoltaic array is variable and when the actual power output of the inverter does correlate with the expected power output of the inverter; and
determines a beginning time and an end time of a period of clipping.

10. The system of claim 1, wherein the loss quantifier module:
determines an amount of power lost during a period of time the photovoltaic string or inverter is generating less power than expected; and
determines a value of the amount of power lost.

11. The system of claim 1, wherein the loss quantifier module analyzes information from a second photovoltaic array, the information comprising at least one of an expected power output of the second photovoltaic array, an actual power output of the second photovoltaic array, and an amount of error associated with a model of the second photovoltaic array.

12. The system of claim 1, wherein the reason the photovoltaic string or inverter is generating less power than expected is at least one of snow cover, soiling, and clipping.

13. The system of claim 1, wherein report module:
generates a report using information received from the loss quantifier module; and
displays the report on at least one of a user interface display associated with a computer, a text message, an email message, or a printed report.

14. A method of analyzing the performance of a photovoltaic array, the method comprising:
providing a non-transitory computer readable medium including an expected output module, a performance module, and a loss quantifier module associated with a computer processor;
determining an expected power output of one or more photovoltaic strings and inverters of the photovoltaic array;
identifying a photovoltaic string or inverter that is generating less power than expected;
receive the expected power output of the photovoltaic string or inverter that is generating less power than expected;
comparing, for the photovoltaic string or inverter that is generating less power than expected, the expected power output to an actual power output; and
determining a reason the photovoltaic string or inverter is generating less power than expected.

15. The method of claim 14, further comprising:
analyzing a ratio of the actual power output of the photovoltaic string or inverter to the expected power output of the photovoltaic string or inverter, wherein snow cover is the reason the photovoltaic string or inverter is generating less power than expected when there is a steady drop in the ratio of the actual power output to the expected power output;
determining a beginning time and an end time of a period of snow cover; and
determining an amount of snow cover is decreasing when there is a steady increase in the ratio of the actual power output to the expected power output.

16. The method of claim 14, further comprising:
analyzing a ratio of the actual power output of the photovoltaic string or inverter to the expected power output of the photovoltaic string or inverter, wherein soiling is the reason the photovoltaic string or inverter is generating less power than expected when a straight line fitted to the ratio has a negative slope over a period of two or more days;
determining an amount of soiling has decreased when the ratio has a positive slope; and
determining a beginning time and an end time of a period of soiling.

17. The method of claim 14, further comprising:
analyzing the actual power output of the photovoltaic string or inverter to the expected power output of the photovoltaic string or inverter, wherein clipping is the reason the photovoltaic string or inverter is generating less power than expected when the actual power output of the inverter is substantially constant during a period of time when irradiance at the photovoltaic array is variable and when the actual power output of the inverter does correlate with the expected power output of the inverter; and
determining a beginning time and an end time of a period of clipping.

18. The method of claim 14, further comprising:
determining an amount of power lost during a period of time the photovoltaic string or inverter is generating less power than expected;
determining a value of the amount of power lost;
generating a report using information received from the loss quantifier module; and
displaying the report on at least one of a user interface display associated with a computer, a text message, an email message, or a printed report.

19. A non-transitory computer-readable medium containing computer executable instructions that, when executed by a processor, cause the processor to execute a method of analyzing the performance of a photovoltaic array, the computer-readable instructions comprising:
instructions to determine an expected power output of one or more photovoltaic strings and inverters of the photovoltaic array;
instructions to identify a photovoltaic string or inverter that is generating less power than expected;
instructions to receive the expected power output of the photovoltaic string or inverter that is generating less power than expected;
instructions to compare the expected power output to an actual power output of the photovoltaic string or inverter that is generating less power than expected;
instructions to determine a reason the photovoltaic string or inverter is generating less power than expected, wherein the reason the photovoltaic string or inverter is generating less power than expected is at least one of snow cover, soiling, and clipping;
instructions to determine an amount of power lost during a period of time the photovoltaic string or inverter is generating less power than expected;
instructions to determine a value of the amount of power lost;
instructions to generate a report, wherein the report includes the reason, the amount of power lost during the period of time, and the value of the amount of power lost during the period of time; and
instructions to display the report on at least one of a user interface display associated with a computer, a text message, an email message, or a printed report.

20. The non-transitory computer readable medium of claim 19, further comprising:
instructions to determine snow cover is the reason the photovoltaic string or inverter is generating less power than expected by analyzing a ratio of the actual power output of the photovoltaic string or inverter to the expected power output of the photovoltaic string or inverter;
instructions to determine soiling is the reason the photovoltaic string or inverter is generating less power than expected when a straight line fitted to the ratio of the actual power output of the photovoltaic string or inverter to the expected power output of the photovoltaic string or inverter has a negative slope over a period of two or more days;
instructions to determine clipping is the reason the photovoltaic string or inverter is generating less power than expected when the actual power output of the inverter is substantially constant during a period of time when irradiance at the photovoltaic array is variable and when the actual power output of the inverter does correlate with the expected power output of the inverter; and
instructions to determine a beginning time and an end time of the period of time the photovoltaic string or inverter is generating less power than expected.
